(19) United States
(12) Patent Application Publication
(10) Pub. No.: US 2012/0109901 A1
(43) Pub. Date: May 3, 2012

(54) CONTENT CLASSIFICATION APPARATUS, CONTENT CLASSIFICATION METHOD, AND CONTENT CLASSIFICATION PROGRAM

(75) Inventor: Ryota Mase, Minato-ku (JP)

(73) Assignee: NEC CORPORATION, Minato-ku, Tokyo (JP)

(21) Appl. No.: 13/381,818

(22) PCT Filed: May 14, 2010
(86) PCT No.: PCT/JP2010/003265

§ 371 Date: Dec. 30, 2011

(30) Foreign Application Priority Data
Jul. 1, 2009 (JP) 2009-156674
Aug. 18, 2009 (JP) 2009-189459

(51) Int. Cl. G06F 7/00

(52) U.S. Cl. 707/687; 707/E17.019

(57) ABSTRACT

Event occurrence information storing means stores event occurrence information in which an event into which a content is classified is associated with photographic acquisition information including shooting date information indicative of the date when the content was shot. Event occurrence information correcting means corrects the event occurrence information based on shooting date information for multiple years and a base year. On condition that the shooting date information on the content to be classified corresponds to the date of the event occurrence information corrected by the event occurrence information correcting means, event determination means determines an event determined to be likely among events corresponding to the date of the event occurrence information to be the event into which the content should be classified.

### TECHNICAL FIELD

The present invention relates to a content classification apparatus, a content classification method, and a content classification program for classifying contents by event.

### BACKGROUND ART

In addition to the recent widespread use of digital cameras and camera-equipped cellular phones, enormous photos and videos have been accumulated in personal computers and the like as built-in memories and media have increased in capacity and become cheaper. Under such circumstances, there is proposed a technique for automatically classifying multiple photographed contents on a per-group basis.

Patent Literature (PTL) 1 discloses an image processing method and an image processor capable of outputting prints with high-definition images stably. In the image processing method described in PTL 1, a feature amount of an image supplied is calculated, and using the feature amount of the image, the image is classified by scene information, such as portrait, flower, or still life. Further, in the image processing method described in PTL 1, images are grouped by using information in addition to the scene information, such as shooting date, shooting time, shooting magnification, and the presence or absence of flash exposure, as means for editing an “index print” in which all images taken with a camera are formed on one print.

PTL 2 discloses a photographic image sorting apparatus for enabling automatic selection of shots desired by a user from among multiple photographic images. The photographic image sorting apparatus described in PTL 2 analyzes scene characteristics, such as colors of photographic images and shapes of subjects, to classify images having similar scene characteristics into the same similar photographic image group. The photographic image sorting apparatus described in PTL 2 also classifies images into similar photographic image groups based on shooting conditions, such as shooting date and time, location, and camera orientation, attached as adjunct information on each image.

PTL 3 discloses an image display device and an image display method capable of extracting image data suited for a slide show from among vast amounts of image data. In the image display method described in PTL 3, image data are grouped according to metadata contained in each image data and attribute information on a person(s) included in an image of the image data.

PTL 4 discloses a content categorizing method and device capable of classifying contents efficiently to present the contents to a user. In the content categorizing method described in PTL 4, input contents are classified according to a classification rule stored in a classification rule database based on attributes, such as the shooting time, location, and direction of each content, information on a person as a photographer of the content, and a degree of similarity to a representative content.

PTL 5 discloses an image processing device capable of readily and accurately classifying the contents of images. In the image processing device described in PTL 5, a related information analyzing part extracts and analyzes information usable for classification of photographed image data. Further, the related information analyzing part analyzes related information (location, date and time, conditions, etc.) related to the situation in which the image data was photographed. Then, a classification predicting part classifies image data into events (sports day, birthday, etc.) based on a predetermined prediction rule and the analysis results by stochastically giving a degree of conformance to the rule or the like.

### CITATION LIST

### Patent Literatures

PTL 1: Japanese Patent Application Publication No. 2008-146657 (Paragraphs 0009, 0038, and 0058)
PTL 2: Japanese Patent No. 3984175 (Paragraphs 0009 and 0013)
PTL 3: Japanese Patent Application Publication No. 2008-131330 (Paragraphs 0005 and 0008)
PTL 4: Japanese Patent Application Publication No. 2004-280254 (Paragraphs 0018 and 0022)
PTL 5: Japanese Patent Application Publication No. 2008-165700 (Paragraphs 0043, 0061, and 0069 to 0073)

### SUMMARY OF INVENTION

### Technical Problems

The image processor described in PTL 1 and the photographic image sorting apparatus described in PTL 2 use such a nature that contents in the same scene (which may also be referred to as “event”) are pictorially similar when classifying photos or videos. For example, the image processor described in PTL 1 extracts image feature quantities from input images to classify the image into classification destinations depending on the similarities among the image feature quantities. However, in this case, there is a problem that images pictorially similar but different in scene cannot be determined. For example, in the image processor described in PTL 1, if there are images different in scene but exhibiting no great distinction in terms of the image feature quantity (e.g. images of “graduation ceremony” and “entrance ceremony”), the images cannot be classified into the respective scenes.

Further, the image display device described in PTL 3 and the content classification method described in PTL 4 use such a nature that contents representing the same scene are similar in shooting conditions, such as time and location, in classifying photos or videos.

In this case, the contents can be grouped by metadata (attribute) contained in image data (contents), such as the time, location, and shooting conditions, giving a group name to each group. However, there is a problem with this method that no determination can be made as to at what kind of event (Christmas, Halloween, Doll Festival, entrance ceremony, sports day, or the like) each piece of image data was taken, and hence that respective pieces of image data cannot be classified by event.

The image processing device described in PTL 5 classifies events of image data based on a rule for associating an event with a shooting date. However, if an event is associated with a specific shooting date, image data taken on a date other than the date cannot be classified correctly. Therefore, for example, if information about an event varying in annual schedule is to be set, the rule will have to be set in each case, causing a problem of increasing the setup load. In PTL 5, a technique for stochastically giving a degree of conformance to the rule is also disclosed. However, in this technique, since a probability is given to each rule after the rule is set, there is a problem that the rule setup load is still high. On the other hand, if an event is associated with a certain period (e.g. on a monthly basis) of shooting dates, candidates for image data that follow the same rule will increase. As a result, there is a problem that image data cannot be classified properly.

Therefore, it is an object of the present invention to provide a content classification apparatus, a content classification method, and a content classification program capable of classifying contents into appropriate events even if content images representing different events are similar while reducing the load to set up information for classifying the events.

### Solution to Problems

A content classification apparatus according to the present invention is characterized by comprising: event occurrence information storing means for storing event occurrence information as information in which an event into which a content is classified is associated with photographic acquisition information as content metadata including shooting date information indicative of the date when the content was shot; event determination means for determining an event determined to be likely among events corresponding to photographic acquisition information in the event occurrence information to be an event into which the content should be classified on condition that the photographic acquisition information on the content to be classified corresponds to the photographic acquisition information in the event occurrence information; and event occurrence information correcting means for correcting the event occurrence information based on shooting date information for multiple years and a base year as a year used as a basis for comparing the shooting date information, wherein on condition that the shooting date information on the content to be classified corresponds to the date of the event occurrence information corrected by the event occurrence information correcting means, the event determination means determines an event determined to be likely among the events corresponding to the date of the event occurrence information to be the event into which the content should be classified.

A content classification apparatus according to another aspect of the present invention is characterized by comprising: event occurrence information storing means for storing event occurrence information as information in which an event into which a content is classified is associated with photographic acquisition information as metadata on the shot content; and event determination means for determining an event determined to be likely among events corresponding to photographic acquisition information in the event occurrence information to be an event into which the content should be classified on condition that the photographic acquisition information on the content to be classified corresponds to the photographic acquisition information in the event occurrence information, wherein the event occurrence information storing means stores a likelihood as a value calculated based on photographic acquisition information on multiple contents associated with each event to indicate a degree of likelihood of the event identified by the photographic acquisition information or a function for calculating the likelihood, and the event determination means determines, to be likely, an event higher in likelihood corresponding to the photographic acquisition information on the content to be classified.

A content classification method according to the present invention is characterized by comprising: correcting event occurrence information as information, in which an event into which a content is classified is associated with photographic acquisition information including shooting date information as content metadata to indicate the date when the content was shot, based on the shooting date information for multiple years and a base year as a year used as a basis for comparing the shooting date information; and determining an event determined to be likely among events corresponding to the date of the corrected event occurrence information to be an event into which the content should be classified on condition that the shooting date information on the content to be classified corresponds to the date of the event occurrence information.

A content classification method according to another aspect of the present invention is characterized by comprising, on condition that event occurrence information as information, in which an event into which a content is classified is associated with photographic acquisition information as metadata on the shot content, corresponds to photographic acquisition information on the content to be classified, determining an event determined to be likely among events in the event occurrence information corresponding to the photographic acquisition information to be an event into which the content should be classified, wherein upon determining the event into which the content should be classified, based on a likelihood as a value calculated based on photographic acquisition information on multiple contents associated with each event to indicate a degree of likelihood of the event identified by the photographic acquisition information, an event higher in likelihood corresponding to the photographic acquisition information on the content to be classified is determined to be likely.

A content classification program according to the present invention, which is installed on a computer including event occurrence information storing means for storing event occurrence information as information in which an event into which a content is classified is associated with photographic acquisition information as content metadata including shooting date information indicative of the date when the content was shot, characterized by causing the computer to perform: event determination processing for determining an event determined to be likely among events corresponding to photographic acquisition information in the event occurrence information to be an event into which the content should be classified on condition that the photographic acquisition information on the content to be classified corresponds to the photographic acquisition information in the event occurrence information; and event occurrence information correction processing for correcting the event occurrence information based on shooting date information for multiple years and a base year as a year used as a basis for comparing the shooting date information, wherein in the event determination processing, on condition that the shooting date information on the content to be classified corresponds to a date of the event occurrence information corrected by the event occurrence information correcting means, an event determined to be likely among the events corresponding to the date of the event occurrence information is determined to be the event into which the content should be classified.

A content classification program according to another aspect of the present invention, which is installed on a computer including event occurrence information storing means for storing a likelihood as a value, calculated based on event occurrence information as information in which an event into which a content is classified is associated with photographic acquisition information as metadata on the shot content, and photographic acquisition information on multiple contents associated with each event, to indicate a degree of likelihood of the event identified by the photographic acquisition information, or a function for calculating the likelihood, characterized by causing the computer to perform event determination processing for determining an event determined to be likely among events corresponding to photographic acquisition information in the event occurrence information to be the event into which the content should be classified on condition that the photographic acquisition information on the content to be classified corresponds to the photographic acquisition information in the event occurrence information, wherein in the event determination processing, an event higher in likelihood corresponding to the photographic acquisition information on the content to be classified is determined to be likely.

### Advantageous Effects of Invention

According to the present invention, even if images of contents representing different events are similar to each other, not only can these contents be classified into appropriate events, but also the load of setting information for classifying the events can be reduced.

### BRIEF DESCRIPTION OF DRAWINGS

FIG. 1 It depicts a block diagram showing an example of a content classification apparatus according to a first exemplary embodiment.

FIG. 2 It depicts a block diagram showing an example of event determination means 12.

FIG. 3 It depicts a block diagram showing an example of event occurrence information managing means 203.

FIG. 4 It depicts a block diagram showing an example of event occurrence information estimating means 2301.

FIG. 5 It depicts a flowchart showing an example of processing performed by the content classification apparatus.

FIG. 6 It depicts a block diagram showing an example of a content classification apparatus according to a second exemplary embodiment.

FIG. 7 It depicts a block diagram showing an example of event determination means 16.

FIG. 8 It depicts a block diagram showing an example of event identifying means 602.

FIG. 9 It depicts a flowchart showing processing performed by the content classification apparatus.

FIG. 10 It depicts a block diagram showing an example of event identifying means 602.

FIG. 11 It depicts a block diagram showing an example of event identifying means 602.

FIG. 12 It depicts a block diagram showing an example of event determination means 16 in a third alternative embodiment.

FIG. 13 It depicts a block diagram showing an example of a content classification apparatus according to a third exemplary embodiment.

FIG. 14 It depicts a block diagram showing an example of event determination means 12′.

FIG. 15 It depicts a block diagram showing an example of event occurrence information managing means 201.

FIG. 16 It depicts a flowchart showing an example of processing performed by the content classification apparatus.

FIG. 17 It depicts a block diagram showing an example of a content classification apparatus according to a fourth exemplary embodiment.

FIG. 18 It depicts a block diagram showing an example of event determination means 17.

FIG. 19 It depicts a flowchart showing an example of processing performed by the content classification apparatus.

FIG. 20 It depicts a block diagram showing a minimal configuration of the present invention.

FIG. 21 It depicts a block diagram showing another minimal configuration of the present invention.

### DESCRIPTION OF EMBODIMENTS

Exemplary embodiments of the present invention will now be described with reference to the accompanying drawings.

### Exemplary Embodiment 1

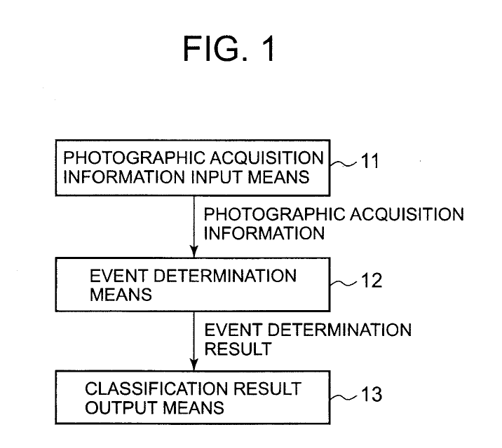

FIG. 1 is a block diagram showing an example of a content classification apparatus according to a first exemplary embodiment of the present invention. The content classification apparatus in the exemplary embodiment includes photographic acquisition information input means 11, event determination means 12, and classification result output means 13. When photographic acquisition information on a content to be classified is input, the photographic acquisition information input means 11 notifies the event determination means 12 of the information. Examples of contents include photos, videos (including short clips), sound and voice, and the like. Further, the photographic acquisition information is content metadata including not only information indicative of the date and location, the shooting environment, and the state of each of photos or videos taken with an imaging device, but also information indicative of the date and location and the like of sound and voice recorded with the imaging device, a recorder, or the like. In the exemplary embodiment, it is assumed that shooting date information is always included in the photographic acquisition information.

The photographic acquisition information may be, for example, information based on EXIF (Exchangeable Image File Format) as an image file standard. Further, for example, information such as the shooting date and time, GPS (Global Positioning System) information, the number of pixels, the ISO (International Organization for Standardization) speed, and the color space may be included in the photographic acquisition information.

For example, when a user enters the photographic acquisition information through an input part (not shown) of the content classification apparatus, the photographic acquisition information input means 11 may also notify the event determination means 12 of the information. Alternatively, if the content classification apparatus includes photographic acquisition information extracting means (not shown) for extracting photographic acquisition information from the content, the photographic acquisition information input means 11 may receive the photographic acquisition information from the photographic acquisition information extracting means and notify the event determination means 12 of the information.

Based on the photographic acquisition information received from the photographic acquisition information input means 11, the event determination means 12 determines to which event the input content belongs from among candidates of events into which contents are classified and which was set up beforehand (hereinafter referred to as classification destination events). Then, the event determination means 12 notifies the classification result output means 13 of the determination result. Here, the event is information used for classifying contents and different from the attributes of the contents themselves (i.e., the photographic acquisition information).

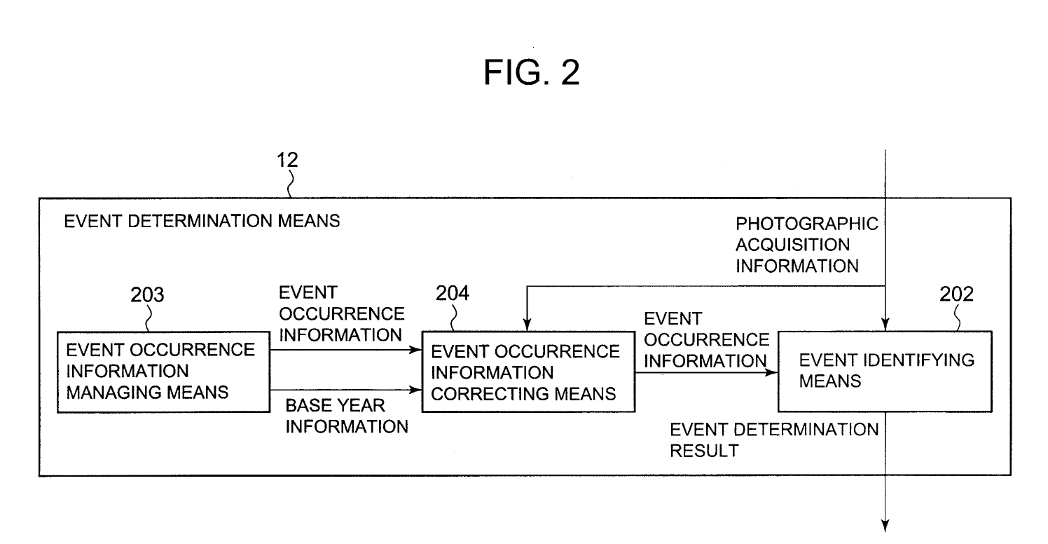

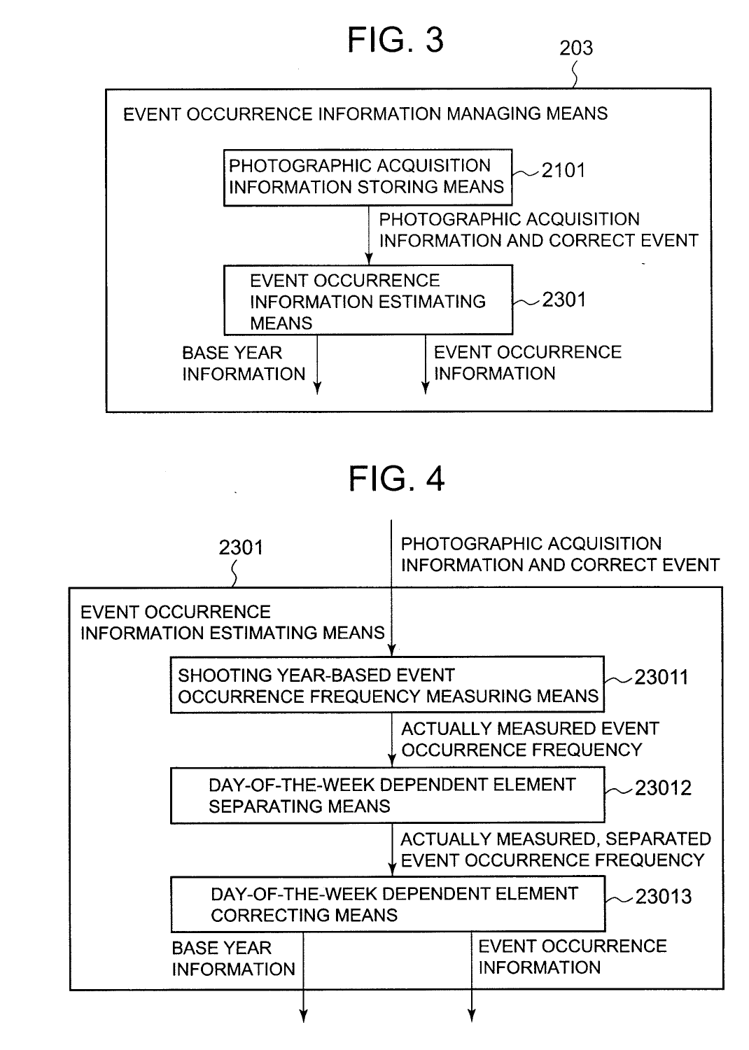

FIG. 2 is a block diagram showing an example of the event determination means 12. The event determination means 12 includes event occurrence information managing means 203, event occurrence information correcting means 204, and event identifying means 202. FIG. 3 is a block diagram showing an example of the event occurrence information managing means 203. The event occurrence information managing means 203 includes photographic acquisition information storing means 2101 and an event occurrence information estimating means 2301.

The photographic acquisition information storing means 2101 is implemented by a magnetic disk drive or the like included in the content classification apparatus to store various kinds of photographic acquisition information in association with classification destination events. The photographic acquisition information stored in the photographic acquisition information storing means 2101 may be, for example, photographic acquisition information manually entered by the user through an input part (not shown) included in the content classification apparatus. Alternatively, if the content classification apparatus includes photographic acquisition information extracting means (not shown) for extracting photographic acquisition information from the content, the photographic acquisition information storing means 2101 may store the photographic acquisition information extracted by the photographic acquisition information extracting means. For example, when the shooting date and time and the event name are included in information representing the content of a photo, the photographic acquisition information extracting means (not shown) may extract the shooting date and time and the event name to store these pieces of information in the photographic acquisition information storing means 2101 in association with each other.

The classification destination event stored by the photographic acquisition information storing means 2101 in association with the photographic acquisition information is an event to which each content should belong (i.e., to be linked with each content), and this event may be referred to as a correct event below. In other words, it can be said that the correct event is an event to which the content is expected to belong.

The photographic acquisition information storing means 2101 may store shooting date information extracted from the photographic acquisition information on a photo in association with a preset classification destination event. Further, when a classification destination event is associated with a specific date from the beginning, the photographic acquisition information storing means 2101 may store the date and the classification destination event in association with each other.

In addition, the photographic acquisition information storing means 2101 may store dates during a certain period and an event in association with each other. For example, there are cases where a period for an event like the entrance ceremony can be known by checking over the date of the entrance ceremony of each school beforehand though the dates somewhat vary from school to school. The photographic acquisition information storing means 2101 may store the period for the event (entrance ceremony) based on the above checking results and the event in association with each other.

In the above description, it is assumed that the shooting date information is included in the photographic acquisition information, but information included in the photographic acquisition information is not limited to the shooting date information. The photographic acquisition information storing means 2101 may store shooting location information as the photographic acquisition information. In this case, the photographic acquisition information storing means 2101 may store shooting location information extracted from photographic acquisition information on a photo in association with an event.

Further, the photographic acquisition information storing means 2101 may store information as a combination of multiple kinds of information (e.g. shooting location information and shooting date information) in association with an event, rather than either the shooting date information or the shooting location information.

In addition, the photographic acquisition information storing means 2101 may store information obtained by counting up, for each shooting date (information such as Δ day of ∘ month), shooting date information extracted from many photos related to a certain event (hereinafter referred to as occurrence frequency information). In other words, it can be said that the occurrence frequency information is information indicating how many photos taken at the certain event there are on each shooting date. Note that the occurrence frequency information is calculated, for example, by a method of counting up information on the same date from among many pieces of shooting date information and further counting up, for each event, how many photos there are on each date. In the following, description will be made about a case where information obtained by counting up shooting date information from among the photographic acquisition information is used as occurrence frequency information, but the photographic acquisition information is not limited to the shooting date information. For example, the shooting location information may be so counted up that information indicating how many photos taken at each shooting location there are will be used as the occurrence frequency information.

In the following, the occurrence frequency information will be described in detail. For example, in the case of focusing on shooting date information in the photographic acquisition information, the occurrence frequency information is information obtained by counting up, for each shooting date (information such as Δ day of ∘ month), the shooting date information extracted from many photos related to each individual event and counting up, for each event, how many photos there are on each shooting date. At this time, the unit of counting up the occurrence frequency information may be each shooting date or a unit with a certain period of shooting dates. In the former case (i.e., where the unit of counting up is each shooting date), the occurrence frequency information is information calculated on a day-to-day basis, while in the latter case (i.e., where the counting unit is a unit with a certain period of shooting dates), the occurrence frequency information is information calculated periodically.

In the above description, the shooting date information is focused on from among the photographic acquisition information. However, the photographic acquisition information counted up as the occurrence frequency information is not limited to the shooting date information, and it may be any other kind of information. For example, the occurrence frequency information may be information obtained by counting up shooting location information from among the photographic acquisition information. The photographic acquisition information storing means 2101 may store this occurrence frequency information in association with the photographic acquisition information and a classification destination event.

From such a nature, it can be said that the occurrence frequency information is information obtained after learning many photos related to the event into which contents are classified and which was set up beforehand (classification destination event) on a per-event basis. If there are two or more events capable of corresponding to a certain kind of photographic acquisition information, it can be said that an event with a higher frequency of occurrence indicated by the occurrence frequency information is such an event that the probability of corresponding to the photographic acquisition information is higher (likely event).

Further, the photographic acquisition information storing means 2101 may store information representing the occurrence frequency information on each event as a probability (hereinafter referred to as occurrence probability information). Note that the occurrence probability information is calculated by performing linear interpolation, Parzen-Window density estimation, normalization, and the like on the occurrence frequency information. Thus, it can be said that the occurrence probability information is a probability representing what is the probability of occurrence of a content belonging to each event per shooting month and day or shooting location. In addition, the photographic acquisition information storing means 2101 may store information on a function used for modeling the occurrence frequency information or the occurrence probability information and a model parameter exhibiting the fittest case.

The following will describe the occurrence probability information in detail. The occurrence probability information is information representing the probability of occurrence of an event with respect to the photographic acquisition information. The occurrence probability information is calculated based on a value obtained by counting up photographic acquisition information on multiple contents on a per-event basis. In other words, it can be said that the occurrence probability information is information representing what is the probability of occurrence of each event based on the occurrence frequency information per shooting month and day or shooting location of contents belonging to the event.

The following will describe a method of calculating the occurrence probability information. The occurrence probability information is calculated by estimating a density from the occurrence frequency information and performing normalization and the like. For example, when Parzen-Window density estimation is performed on shooting date-based occurrence frequency information, a window function (e.g. triangular window function or Gaussian window function) having a window width of several days is defined to position pieces of occurrence frequency information on each event in such a manner that the origin of the window function will be placed on each date. Then, the positioned pieces of occurrence frequency information are superimposed to estimate values (occurrence frequency information) of the surrounding on a per-event basis. In order to represent, as a probability, the estimate of each piece of data (occurrence frequency information) thus obtained for each event, normalization is performed on a per-event basis so that a total value ranging from January 1 to December 31 will be “1.” The photographic acquisition information storing means 2101 stores this occurrence probability information in association with the photographic acquisition information and the classification destination event.

The above description is made about the case where the occurrence probability information is calculated based on the shooting date-based occurrence frequency information. However, the calculation of the occurrence probability information is not limited to that based on the shooting date-based occurrence frequency information. The occurrence probability information may also be calculated based on occurrence frequency information obtained periodically. This means that occurrence probability information is calculated on a day-to-day basis from occurrence frequency information obtained by counting up photos on the same date, and from occurrence frequency information obtained by counting up photos belonging to the certain period, occurrence probability information is calculated periodically. Further, when there are two or more events capable of corresponding to certain kind of photographic acquisition information, it can be said that an event with a higher frequency of occurrence indicated by the occurrence probability information is such an event that the probability of corresponding to the photographic acquisition information is higher (likely event).

Next, the model parameter will be described in detail. The model parameter is a parameter used to decide on a function with a minimal difference from a distribution indicated by the occurrence frequency information or the occurrence probability information for each event (hereinafter referred to as an approximate function). The following description will be made by taking, as an example, a case where the occurrence frequency information or the occurrence probability information is modeled using a complex Gaussian function (GMM: Gaussian Mixture Model).

First, based on the shape of the distribution of occurrence frequency information or occurrence probability information, it is determined whether to use a single Gaussian function or to complexly use two or more Gaussian functions from the number of peaks or the like indicated by the distribution. Further, average and standard deviation values used to decide on the shape of each Gaussian function are so determined that the approximate function will be most approximated (with the least error) to the shape indicated by the distribution of the original occurrence frequency information or occurrence probability information.

Thus, the photographic acquisition information storing means 2101 may store the function(s) (here the Gaussian function(s)) used to decide on the approximate function, the number of functions to be combined, the average and standard deviation values, and the like as model parameters. Since the function(s) is uniquely determined from the model parameters, it can be said that the storage of the model parameters in the photographic acquisition information storing means 2101 is synonymous with the storage of the function(s) in the photographic acquisition information storing means 2101.

In response to a request from classification destination event correcting means 204 to be described later, the event occurrence information estimating means 2301 reads photographic acquisition information (shooting date information) and information on an event (i.e., correct event) corresponding to the photographic acquisition information from the photographic acquisition information storing means 2101, and outputs event information to be estimated from these pieces of information (hereinafter referred to as event occurrence information) and information on a base year (hereinafter referred to as base year information) used in order to total the information on multiple years. Then, the event occurrence information estimating means 2301 notifies the output event occurrence information and base year information to the event occurrence information correcting means 204. The event occurrence information is, for example, information in which the event and the photographic acquisition information are associated.

FIG. 4 is a block diagram showing an example of the event occurrence information estimating means 2301 in the exemplary embodiment. The event occurrence information estimating means 2301 in the exemplary embodiment includes shooting year-based event occurrence frequency measuring means 23011, day-of-the-week dependent element separating means 23012, and day-of-the-week dependent element correcting means 23013.

The shooting year-based event occurrence frequency measuring means 23011 reads shooting date information on contents and information on correct events from the photographic acquisition information storing means 2101 to count up the number of contents corresponding to each event for each date identified by the shooting date information. Since the number of contents counted up by the shooting year-based event occurrence frequency measuring means 23011 is information representing how much each event occurs on each date, it can be said that the number of contents is event occurrence frequency information. This shooting year-based event occurrence frequency measuring means 23011 counts up the event occurrence frequency information per shooting year based on the year identified by the shooting date information (hereinafter referred to as shooting year).

Using the above-mentioned method of counting up the occurrence frequency information, the shooting year-based event occurrence frequency measuring means 23011 may also count up the number of contents corresponding to each event for each date identified by the shooting date information.

The day-of-the-week dependent element separating means 23012 receives the event occurrence frequency information counted up per shooting year by the shooting year-based event occurrence frequency measuring means 23011. Then, assuming that “each event occurs dependently on either a specific date or a day of the week,” the day-of-the-week dependent element separating means 23012 separates the received event occurrence frequency information into two kinds of event occurrence frequency information (hereinafter referred to as “element”) based on this assumption.

A first kind of element is an element in the event occurrence frequency information dependent on such a day that the appearance of a peak of the number of contents in the event occurrence frequency information can be identified beforehand (hereinafter referred to as “date-dependent element”). It can be said that this element is an element dependent on the same date every year and the date on which the occurrence frequency is likely to be maximum does not vary year by year. A second kind of element is an element depending on a day of the week in the event occurrence frequency information (hereinafter referred to as “day-of-the-week dependent element”) when there is no influence of the date-dependent element at all. Since the day of the week of this element on the same date vary year by year, it can be said that the day-of-the-week dependent element in the event occurrence frequency information is such an element that a date when the occurrence frequency is likely to be high also vary year by year depending on the year.

Among values on a specific day in the event occurrence frequency information, the day-of-the-week dependent element separating means 23012 considers the day-of-the-week dependent element as being equivalent to those before and after the specific date to calculate the day-of-the-week dependent element on the specific day as an average value of the event occurrence frequency information on days before and after the specific day. At this time, the date-dependent element can be considered as a value calculated by subtracting the day-of-the-week dependent element from the event occurrence frequency information. Such a calculation method is referred to as separation method example 1 below.

The following will described the separation method example 1. For a certain event, date-dependent element gk(d) and day-of-the-week dependent element hk(d) in event occurrence frequency information fk(d) for year k are calculated by the following equations (1) and (2), respectively:

$$\begin{matrix} {g}_{k} ( d ) = \{ {f}_{k} ( d ) - \frac{{f}_{k} ( d - 1 ) + {f}_{k} ( d + 1 )}{2} \} δ ( d - {d}_{b} ) & [ Math . 1 ] \\ {h}_{k} ( d ) = [ {f}_{k} ( d ) - \{ {f}_{k} ( d ) - \frac{{f}_{k} ( d - 1 ) + {f}_{k} ( d + 1 )}{2} \} δ ( d - {d}_{b} ) ] & [ Math . 2 ]\end{matrix}$$

Here, d denotes a numeric value from 1 to 366 labeled in order from January 1 to December 31, δ(d) denotes such a Kronecker delta function that is 1 when D=0 or 0 when d≠0, db denotes a label value corresponding to specific day b on which the peak of the event occurrence frequency information can be considered to appear, respectively.

The following description will be made about a case where the day-of-the-week dependent element separating means 23012 performs processing using the separated date-dependent element gk(d) and day-of-the-week dependent element hk(d) according to the separation method example 1. Note that the method of separating between the date-dependent element gk(d) and the day-of-the-week dependent element hk(d) is not limited to the separation method example 1. For example, the day-of-the-week dependent element separating means 23012 may use, as the value of the day-of-the-week dependent element, a value of the event occurrence frequency information on the day before or after the specific day. Alternatively, the day-of-the-week dependent element separating means 23012 may assume a function model to separate between the date-dependent element gk(d) and the day-of-the-week dependent element hk(d) by a method such as independent component analysis.

The day-of-the-week dependent element correcting means 23013 makes a correction to the day-of-the-week dependent element separated by the day-of-the-week dependent element separating means 23012, and outputs the corrected event occurrence information and the base year information.

A method of correcting the day-of-the-week dependent element will be described. The date-dependent element gk(d) and the day-of-the-week dependent element hk(d) as the event occurrence frequency information separated by the day-of-the-week dependent, element separating means 23012 are both information per shooting year. Therefore, the day-of-the-week dependent element correcting means 23013 creates information in which these elements get together over multiple years. First, the day-of-the-week dependent element correcting means 23013 sets a base year. Then, the day-of-the-week dependent element correcting means 23013 maps (consolidates) the date-dependent element gk(d) and the day-of-the-week dependent element hk(d) counted up per shooting year into the base year, and overlaps these elements to calculate date-dependent element F1(d) and the day-of-the-week dependent element F2(d) common in shooting year. As mentioned above, since the day-of-the-week dependent element in the event occurrence frequency information vary year by year, the day-of-the-week dependent element correcting means 23013 calculates F1(d) and F2(d) by the following equations (3), and (4) in consideration of annual differences:

$$\begin{matrix}{F}_{1} ( d ) = \frac{1}{m} {\sum }_{k = 1}^{m} \frac{1}{{N}_{k}} \{ {f}_{k} ( d ) - \frac{{f}_{k} ( d - 1 ) + {f}_{k} ( d + 1 )}{2} \} δ ( d - {d}_{b} ) & [ Math . 3 ] \\ {F}_{2} ( d ) = \frac{1}{m} {\sum }_{k = 1}^{m} \frac{1}{{N}_{k}} [ {f}_{k} ( {d}^{′} ) - \{ {f}_{k} ( {d}^{′} ) - \frac{{f}_{k} ( {d}^{′} - 1 ) + {f}_{k} ( {d}^{′} + 1 )}{2} \} δ ( d - {d}_{b} ) ] & [ Math . 4 ]\end{matrix}$$

Here, it is assumed that m denotes the total number of event occurrence frequency information used per shooting year, and Nk denotes the total number of contents in shooting year k used to actually measure the event occurrence frequency information. Further, it is assumed that D0 is a day of the week on the base day in a preset base year (where Sunday is 0, Monday is 1, Tuesday is 2, . . . , Saturday is 6), and Dk is a day of the week of the base day in year k. Here, when Δdk is a value calculated by Dk-D0, d′ denotes d-Δdk.

The day-of-the-week dependent element correcting means 23013 outputs the date-dependent element F1(d) and the day-of-the-week dependent element F2(d) calculated by the equation (3) and equation (4) as event occurrence information common in shooting year. The day-of-the-week dependent element correcting means 23013 also outputs the set base year as base year information. Note that the event occurrence information output by the day-of-the-week dependent element correcting means 23013 is not limited to the date-dependent element F1(d) and the day-of-the-week dependent element F2(d).

For example, the day-of-the-week dependent element correcting means 23013 may perform density estimation such as linear interpolation or Parzen-Window on each of the two kinds of elements to calculate the date-dependent element p1(d) and the day-of-the-week dependent element p2(d) as an event occurrence probability distribution. In this case, the day-of-the-week dependent element correcting means 23013 may output the calculated event occurrence probability distribution as event occurrence information.

In this case, the day-of-the-week dependent element correcting means 23013 may calculate the event occurrence probability distribution using the above-mentioned method of calculating the occurrence probability information or a function defined by the model parameter.

Here, processing performed by the day-of-the-week dependent element correcting means 23013 will be described by using a specific example. For example, suppose that event occurrence frequency information (e.g. information indicating how many photos there are on Δ day of ∘ month as the shooting date) in the 2000 year, event occurrence frequency information in the 2001 year, event occurrence frequency information in the 2002 year, . . . are extracted from the photographic acquisition information on many photos, videos, or audio data. In this case, when superimposing event occurrence frequency information in all years, the day-of-the-week dependent element correcting means 23013 fixes only the event occurrence frequency information in a certain year on the ground that the day of the week on the same date (such as Δ day of ∘ month) will vary year by year. Then, the day-of-the-week dependent element correcting means 23013 superimposes the other pieces of event occurrence frequency information on the event occurrence frequency information in the fixed year while shifting the dates of the event occurrence frequency information in the other years in accordance with the variations in the day of the week. Here, the fixed year is the “base year.” Thus, it can be said that the “base year” set by the day-of-the-week dependent element correcting means 23013 is the shooting year of a destination to which the other pieces of event occurrence frequency information are mapped upon mapping and superimposing the event occurrence frequency information counted up on a per-year basis.

As mentioned above, even when the shooting dates of input contents are the same date, they may vary in day of the week if the shooting year is different from the base year. The influence of the variations in day of the week can be eliminated by setting the base year to superimpose event occurrence frequency information.

The event occurrence information correcting means 204 receives the event occurrence information and the base year information from the event occurrence information managing means 203, and photographic acquisition information including shooting date information from the photographic acquisition information input means 11, respectively, to correct and output event occurrence information. The event occurrence information correcting means 204 compares information on the shooting year in the received shooting date information with the base year information, calculates the degree of variation in day of the week on the same date, and corrects the event occurrence information in accordance with the correspondence between the date and the day of the week in the base year.

For example, when the event occurrence information managing means 203 outputs, as the event occurrence information, information including an event occurrence probability distribution (p1(d), p2(d), and the like), the event occurrence information correcting means 204 may shift the day-of-the-week dependent element to correct the event occurrence information using a calculating formula p1(d)+p2(d+Δdk).

Based on the photographic acquisition information input into the photographic acquisition information input means 11 and the corrected event occurrence information, the event identifying means 202 determines to which event the contents indicated by the photographic acquisition information belong, and outputs the determination result. In other words, among events corresponding to the photographic acquisition information in the event occurrence information, the event identifying means 202 determines an event determined to be likely to be the classification destination event of the contents. For example, when the shooting date information included in the photographic acquisition information input into the photographic acquisition information input means 11 matches the date included in the event occurrence information, the event identifying means 202 may determines that the contents indicated by the photographic acquisition information belong to the event determined to be likely among the events in the event occurrence information corresponding to the photographic acquisition information.

Note that such a determination that the contents indicated by the photographic acquisition information belong to the event determined to be likely among the events in the event occurrence information corresponding to the photographic acquisition information is not limited to the case where the photographic acquisition information input into the photographic acquisition information input means 11 matches the photographic acquisition information included in the event occurrence information. For example, when the pieces of photographic acquisition information to be compared match with each other to a predetermined extent, the event identifying means 202 may determine that the contents indicated by the photographic acquisition information belong to the event determined to be likely among the events in the event occurrence information corresponding to the photographic acquisition information.

As a result of the determination, the event identifying means 202 notifies the classification result output means 13 of the name of the event to which the contents have been determined to belong, a number corresponding to each event, and the like. The number of event candidates to be notified to the event identifying means 202 may be one or more.

The classification result output means 13 outputs the determination result received from the event determination means 12. For example, when information is notified through a memory to another means (not shown) using the determination result, the classification result output means 13 may store the determination result in the memory. The classification result output means 13 may also output the determination result to an output device (not shown) such as a display provided in the content classification apparatus.

The photographic acquisition information input means 11, the event determination means 12 (more specifically, the event occurrence information estimating means 2301, the event identifying means 202, and the event occurrence information correcting means 204), and the classification result output means 13 are implemented by a CPU of a computer operating according to a program (content classification program). Alternatively, the photographic acquisition information input means 11, the event determination means 12 (more specifically, the event occurrence information estimating means 2301, the event identifying means 202, and the event occurrence information correcting means 204), and the classification result output means 13 may be implemented through dedicated hardware, respectively.

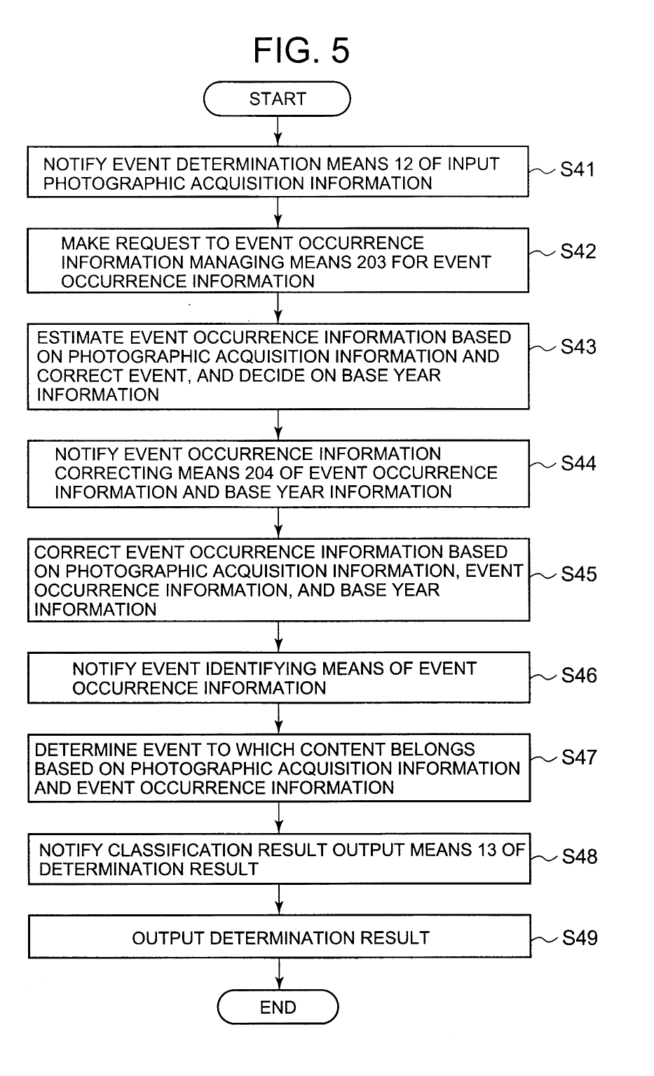

Next, the operation will be described. FIG. 5 is a flowchart showing an example of processing performed by the content classification apparatus according to the exemplary embodiment. For example, when a user enters photographic acquisition information through an input unit (not shown) provided in the content classification apparatus, the photographic acquisition information input means 11 notifies the event determination means 12 of the information (step S41). When the event determination means 12 receives the photographic acquisition information, the classification destination event correcting means 204 makes a request to the event occurrence information managing means 203 for event occurrence information (step S42). When the event occurrence information managing means 203 receives the request, the event occurrence information estimating means 2301 reads photographic acquisition information and a correct event from the photographic acquisition information storing means 2101, estimates event occurrence information based thereon, and decides on base year information as well (step S43). Then, the event occurrence information estimating means 2301 notifies the classification destination event correcting means 204 of the estimated event occurrence information and the base year information (step S44).

Based on the photographic acquisition information including the shooting date information received from the photographic acquisition information input means 11 and the event occurrence information and base year information received from the event occurrence information managing means 203, the event occurrence information correcting means 204 corrects the event occurrence information (step S45). Then, the event occurrence information correcting means 204 notifies the event identifying means 202 of the corrected event occurrence information (step S46). Based on the input photographic acquisition information and the event occurrence information received from the event occurrence information correcting means 204, the event identifying means 202 determines to which event the contents indicated by the photographic acquisition information belong (i.e., an event determined to be likely) (step S47). Then, the event identifying means 202 notifies the classification result output means 13 of the determination result (step S48), and the classification result output means 13 outputs the determination result (step S49).

As described above, according to the exemplary embodiment, the event occurrence information correcting means 204 corrects event occurrence information in which an event into which contents are classified is associated with shooting date information based on the shooting date information for multiple years and the base year information. Then, on condition that the shooting date information on the contents to be classified corresponds to the date of the event occurrence information, the event identifying means 202 determines an event corresponding to the date of the event occurrence information to be a classification destination event of the contents.

Thus, even if images of contents representing different events are similar, not only can these contents be classified into appropriate events, but also the load of setting information used to classify the events can be reduced. In other words, the content classification method in the exemplary embodiment uses photographic acquisition information, such as the occurrence date or occurrence location different from event to event, rather than differences based on the images of the contents to be input, to classify the contents. Therefore, even if it is difficult to classify events based on image differences, an event can be identified by using a difference between photographic acquisition information, improving classification accuracy. Further, even if the date when an event takes place differs year by year, since there is no need to set a rule on a case-by-case basis, not only can the contents representing the event be classified properly, but also the setup load can be reduced.

Further, according to the exemplary embodiment, based on the event occurrence information in which the photographic acquisition information including the shooting date information is associated with each event, the shooting year-based event occurrence frequency measuring means 23011 calculates, for each shooting year, event occurrence frequency information as information obtained by counting up the number of contents corresponding to each event per date identified by the shooting date information. Next, the day-of-the-week dependent element separating means 23012 extracts a day-of-the-week dependent element as an element dependent on the day of the week from among the event occurrence frequency information. Then, based on a day-of-the-week dependent element in each year consolidated according to a difference from the base year information, the day-of-the-week dependent element correcting means 23013 estimates event occurrence information in which an event is associated with a date when the event takes place. The event occurrence information correcting means 204 corrects the estimated event occurrence information based on the base year and the shooting date information. Finally, the event identifying means 202 determines, to be a classification destination event of the contents, an event determined to be likely (e.g. an event with the maximum event occurrence information) with respect to the date of the corrected event occurrence information.

Thus, even if the date when the event takes place differs year by year, the contents representing the event can be classified properly.

### Exemplary Embodiment 2

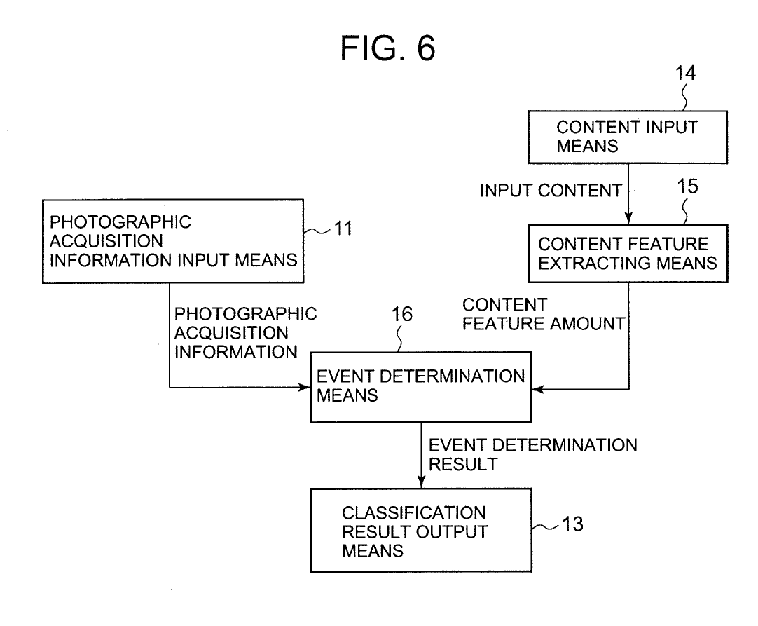

FIG. 6 is a block diagram showing an example of a content classification apparatus according to a second exemplary embodiment of the present invention. Note that the same elements as those in the first exemplary embodiment are given the same reference numerals as those in FIG. 1 to omit redundant description. The content classification apparatus in the exemplary embodiment is different from that in the first exemplary embodiment in that an event determination is made by using a content feature amount as well as the photographic acquisition information.

Here, the content feature amount means the amount of a content feature extracted from contents such as photos, videos, or audio data. In other words, it can be said that the content feature amount is information obtained by converting the feature of the contents into a numeric value. For example, when the contents are photos or videos, the content feature amount is the image edge, color alignment in images, color histogram, edge pattern histogram in each direction, visual feature amount in MPEG-7, or the like. When the contents are acoustic data, the content feature amount is MFCC (Mel-Frequency Cepstrum Coefficient), acoustic power, acoustic feature amount in MPEG-7, or the like.

The content classification apparatus according to the exemplary embodiment includes photographic acquisition information input means 11, classification result output means 13, content input means 14, content feature extracting means 15, and event determination means 16. Since the photographic acquisition information input means 11 and the classification result output means 13 are the same as those in the first exemplary embodiment, redundant description will be omitted. However, note that the photographic acquisition information input into the photographic acquisition information input means 11 is photographic acquisition information used to represent contents input into the content input means 14.

When images taken with an imaging device, such as a digital camera, a digital camcorder, or a cellular phone, or images captured through a scanner or the like are input as contents, the content input means 14 notifies the content feature extracting means 15 of the contents.

The contents to be input may be compressed images such as JPEG or the like or uncompressed images such as TIFF (Tagged Image File Format), PSD (PhotoShop® Data), RAW or the like. The contents to be input may also be compressed videos or videos decoded therefrom. In this case, the content input means 14 has only to receive the input videos on a frame image basis. When the input videos are compressed videos, any compression format may be used, such as MPEG, MOTION JPEG, or “WINDOWS Media Video” (WINDOWS Media is a registered trademark), as long as it is decodable. The input contents are not limited to the images or videos, and they may be audio data or acoustic data.

The content feature extracting means 15 receives the input contents from the content input means 14, and extracts a content feature amount from the input contents. For example, when the input contents are images, the content feature extracting means 15 may apply an edge detection filter, such as 2D Laplacian filter or Canny filter, to extract a content feature amount. Alternatively, the content feature extracting means 15 may extract, as the content feature amount, a feature amount such as color alignment in the input images, color histogram, edge pattern histogram in each direction, or visual feature amount in MPEG-7. When the input contents are acoustic data, the content feature extracting means 15 may extract, as the content feature amount, MFCC, acoustic power, acoustic feature amount in MPEG-7, or the like. The content feature extracting means 15 notifies the event determination means 16 of the extracted content feature amount.

The event determination means 16 determines an event into which the content should be classified from among classification destination events based on photographic acquisition information and the content feature amount. Specifically, the event determination means 16 receives the photographic acquisition information from the photographic acquisition information input means 11 and the content feature amount from the content feature extracting means 15, respectively, to determine, from the classification destination event candidates, to which event the input contents belong. Then, the event determination means 16 notifies the classification result output means 13 of the determination result.

FIG. 7 is a block diagram showing an example of the event determination means 16. The event determination means 16 shown in FIG. 7 includes event identifying means 602, content-featured event occurrence information calculating means 603, content-featured model data storing means 604, event occurrence information on photographic acquisition information managing means 605, and event occurrence information on photographic acquisition information correcting means 606. Since the event occurrence information on photographic acquisition information managing means 605 is the same as the event occurrence information managing means 203 in the first exemplary embodiment, and the event occurrence information on photographic acquisition information correcting means 606 is the same as the event occurrence information correcting means 204 in the first exemplary embodiment, the detailed description thereof will be omitted. Note that, in the following description, event occurrence information calculated by the event occurrence information on photographic acquisition information managing means 605 is referred to as event occurrence information on photographic acquisition information.

The content-featured model data storing means 604 stores information on a model used to identify an event to which contents belong (hereinafter referred to as content-featured model data). For example, when a distribution of content feature amounts extracted from multiple contents is modeled, information describing the model may be set as the content-featured model data. Further, for example, assuming that information indicative of an area determined to be each event in a feature space is described in a Gaussian model, the mean and variance in the feature space necessary to describe the Gaussian model may be set as the content-featured model data. The content-featured model data storing means 604 may also store occurrence probability parameters, support vectors of SVM (Support Vector Machine), projection axis parameters determined by linear discrimination, etc.

The content-featured event occurrence information calculating means 603 calculates content-featured event occurrence information based on the content-featured model data read from the content-featured model data storing means 604 and the content feature amount received from the content feature extracting means 15. Here, it can be said that the content-featured event occurrence information is information indicative of the degree to which each content is classified into each event, i.e., a value indicative of the likelihood of each event. In the following description, this value is referred to as a score value.

For example, when the content-featured model data is information on the centroid of each event class in the feature space, the content-featured event occurrence information calculating means 603 calculates distance from a point, indicated in the feature space by the content feature amount received from the content feature extracting means 15, to the centroid of the above event class. The content-featured event occurrence information calculating means 603 may set, as the content-featured event occurrence information, a ratio to each event according to the distance thus calculated.

Note that the content-featured event occurrence information is not limited to the above-mentioned contents. For example, the content-featured event occurrence information calculating means 603 may use projection axes, determined by linear discriminant analysis for many content feature amounts, as the content-featured model data read from the content-featured model data storing means 604 to set, as the content-featured event occurrence information, an index indicative of the degree to which an input content feature amount is classified into each event. Alternatively, the content-featured event occurrence information calculating means 603 may use support vectors of SVM to set, as the content-featured event occurrence information, an index indicative of the degree to which an input content feature amount is classified into each event.

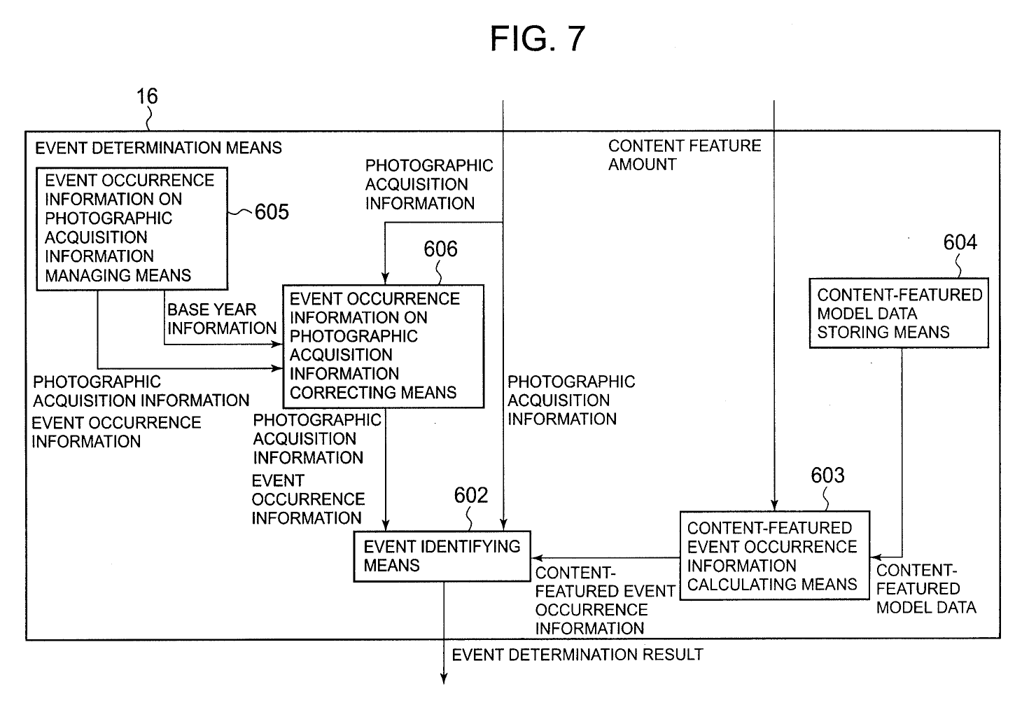

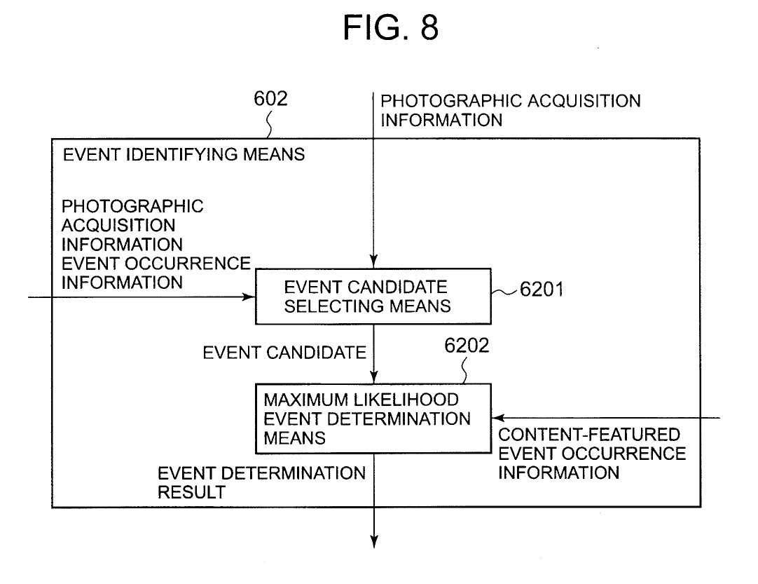

FIG. 8 is a block diagram showing an example of the event identifying means 602 in the exemplary embodiment. The event identifying means 602 in the exemplary embodiment includes event candidate selecting means 6201 and maximum likelihood event determination means 6202. The event candidate selecting means 6201 receives the event occurrence information on photographic acquisition information from the event occurrence information on photographic acquisition information correcting means 606 and the photographic acquisition information from the photographic acquisition information input means 11, respectively, and outputs candidates for an event to which the contents input into the content input means 14 belong. Note that the format of the event occurrence information on photographic acquisition information received from the event occurrence information on photographic acquisition information correcting means 606 is the same as that of the event occurrence information output from the event occurrence information correcting means 204 in the first exemplary embodiment.

For example, when the format of the event occurrence information on photographic acquisition information is information in which the classification destination event of contents is simply associated with the date when the contents take place, the event candidate selecting means 6201 may output, as event candidates, a few top events close in time from the shooting date and time of the photographic acquisition information input from the photographic acquisition information input means 11. Further, for example, the event occurrence information on photographic acquisition information received from the event occurrence information on photographic acquisition information correcting means 606 may be information indicative of the degree to which an event occurs per shooting date or location (i.e., event occurrence frequency information). In this case, the event candidate selecting means 6201 may output, as event candidates, a few top events indicated by the event occurrence frequency information under the condition of the shooting date or location in the photographic acquisition information input into the photographic acquisition information input means 11.

In addition, the event occurrence information on photographic acquisition information may be information obtained by performing density estimation and normalization processing on the event occurrence frequency information and expressing it as a probability (hereinafter referred to as event occurrence probability information). In this case, the event candidate selecting means 6201 may output, as event candidates, a few top events indicated by the event occurrence probability information under the condition of the shooting date or location in the photographic acquisition information input into the photographic acquisition information input means 11. The method of outputting the event candidates may be a method of simply outputting the event names or numbers corresponding to the respective events, or a method of outputting, together with these pieces of information, values of event occurrence frequency information on the event candidates or values of event occurrence probability information.

The maximum likelihood event determination means 6202 receives the event candidates from the event candidate selecting means 6201 and the content-featured event occurrence information from the content-featured event occurrence information calculating means 603, respectively, to output an event determination result. For example, suppose that information received by the maximum likelihood event determination means 6202 as the content-featured event occurrence information is a value (e.g. score value) indicative of the likelihood of each event. Suppose further that the event candidates received from the event candidate selecting means 6201 are only the event names or numbers corresponding to the respective events. In this case, the maximum likelihood event determination means 6202 may output, as the event determination result(s), an event with the top score value in the content-featured event occurrence information corresponding to event candidates, or a few top events.

Further, suppose that the maximum likelihood event determination means 6202 receives values of event occurrence frequency information on event candidates or values of event occurrence probability information from the event candidate selecting means 6201 in addition to the above-mentioned information. In this case, the maximum likelihood event determination means 6202 may calculate values obtained by multiplying the values of the event occurrence frequency information on event candidates or the values of the event occurrence probability information by their score values so that the top event or a few top events will be output as the event determination result(s).

Thus, the event identifying means 602 receives the event occurrence information on photographic acquisition information from the event occurrence information on photographic acquisition information correcting means 606, the photographic acquisition information from the photographic acquisition information input means 11, and the content-featured event occurrence information from the content-featured event occurrence information calculating means 603, respectively, to determine the candidates of the event to which the contents input into the content input means 14 belong, and output the event determination result.

The photographic acquisition information input means 11, the classification result output means 13, the content input means 14, the content feature extracting means 15, and the event determination means 16 (more specifically, the event identifying means 602, the content-featured event occurrence information calculating means 603, the event occurrence information on photographic acquisition information managing means 605, and the event occurrence information on photographic acquisition information correcting means 606) are implemented by a CPU of a computer operating according to a program (content classification program). Alternatively, the photographic acquisition information input means 11, the classification result output means 13, the content input means 14, the content feature extracting means 15, and the event determination means 16 (more specifically, the event identifying means 602, the content-featured event occurrence information calculating means 603, the event occurrence information on photographic acquisition information managing means 605, and the event occurrence information on photographic acquisition information correcting means 606) may be implemented through dedicated hardware, respectively.

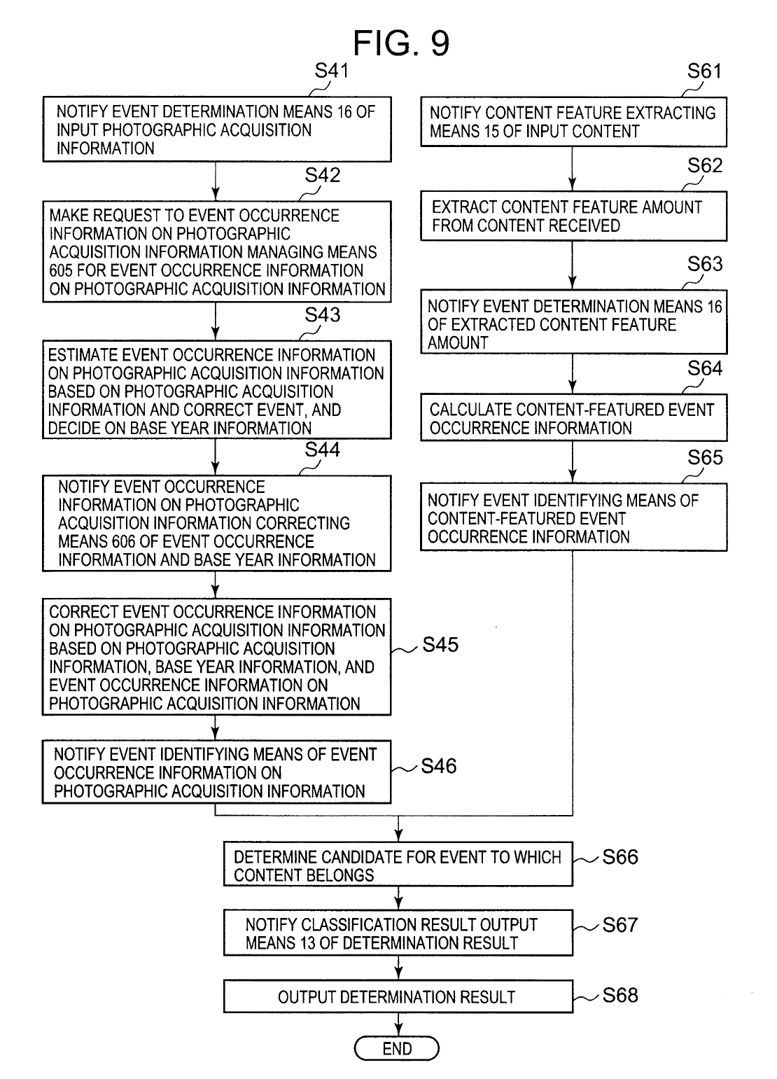

Next, the operation will be described. FIG. 9 is a flowchart showing an example of processing performed by the content classification apparatus according to the exemplary embodiment. Note that the processing from when photographic acquisition information is input into the content classification apparatus until the event occurrence information on photographic acquisition information is notified to the event identifying means 602 is the same as steps S41 to S46 in FIG. 5.

On the other hand, for example, when images taken with an imaging device or the like are input as contents into the content classification apparatus, the content input means 14 notifies the content feature extracting means 15 of the contents (step S61). The content feature extracting means 15 extracts a content feature amount from the contents received from the content input means 14 (step S62), and notifies the event determination means 16 of the extracted content feature amount (step S63).

When the event determination means 16 receives the content feature amount from the content feature extracting means 15, the content-featured event occurrence information calculating means 603 calculates content-featured event occurrence information based on the received content feature amount and content-featured model data read from the content-featured model data storing means 604 (step S64). Then, the content-featured event occurrence information calculating means 603 notifies the event identifying means 602 of the calculated content-featured event occurrence information (step S65).

The event identifying means 602 receives event occurrence information on photographic acquisition information from the event occurrence information on photographic acquisition information correcting means 606, photographic acquisition information from the photographic acquisition information input means 11, and content-featured event occurrence information from the content-featured event occurrence information calculating means 603, respectively, to determine candidates for an event to which the contents input into the content input means 14 belong (step S66). The maximum likelihood event determination means 6202 notifies the classification result output means 13 of the determination results (step S67), and the classification result output means 13 outputs the determination results (step S68).

The following will describe an operation performed in step S66 by the event identifying means 602 to determine candidates for an event to which the contents belong. First, the event candidate selecting means 6201 receives the event occurrence information on photographic acquisition information from the event occurrence information on photographic acquisition information correcting means 606 and the photographic acquisition information from the photographic acquisition information input means 11, respectively, to select the candidates for the event to which the contents belong. Next, the maximum likelihood event determination means 6202 determines an event based on the event candidates selected by the event candidate selecting means 6201 and the content-featured event occurrence information received from the content-featured event occurrence information calculating means 603.

Thus, according to the exemplary embodiment, the content feature extracting means 15 extracts the content feature amount. Then, based on the content feature amount, on condition that the photographic acquisition information on the contents to be classified corresponds to the photographic acquisition information in the event occurrence information, the event determination means 16 determines, as the classification destination event of the contents, an event determined to be likely from among the events corresponding to the photographic acquisition information in the event occurrence information. Thus, since an event is determined by the content feature amount in addition to the photographic acquisition information, the classification accuracy is further improved in addition to the effects of the first exemplary embodiment.

Specifically, the content-featured event occurrence information calculating means 603 calculates the content-featured event occurrence information based on the content-featured model data and the content feature amount. The event candidate selecting means 6201 outputs, as candidates for the classification destination event of the contents, events determined to be likely among the events whose event occurrence information on photographic acquisition information corresponds to the photographic acquisition information on the contents to be classified. Among the output candidates, the maximum likelihood event determination means 6202 determines a classification destination event of the contents based on the degree (e.g. score value) indicated by the content-featured event occurrence information. Thus, classification accuracy is further improved in addition to the effects of the first exemplary embodiment.

Next, a first alternative embodiment of the second exemplary embodiment will be described. The first alternative embodiment differs from the second exemplary embodiment in that the event identifying means 602 includes event candidate selecting means 6203 and maximum likelihood event determination means 6204. The other elements are the same as those shown in FIG. 6 and FIG. 7. The description of the same configuration as that in the second exemplary embodiment will be omitted.

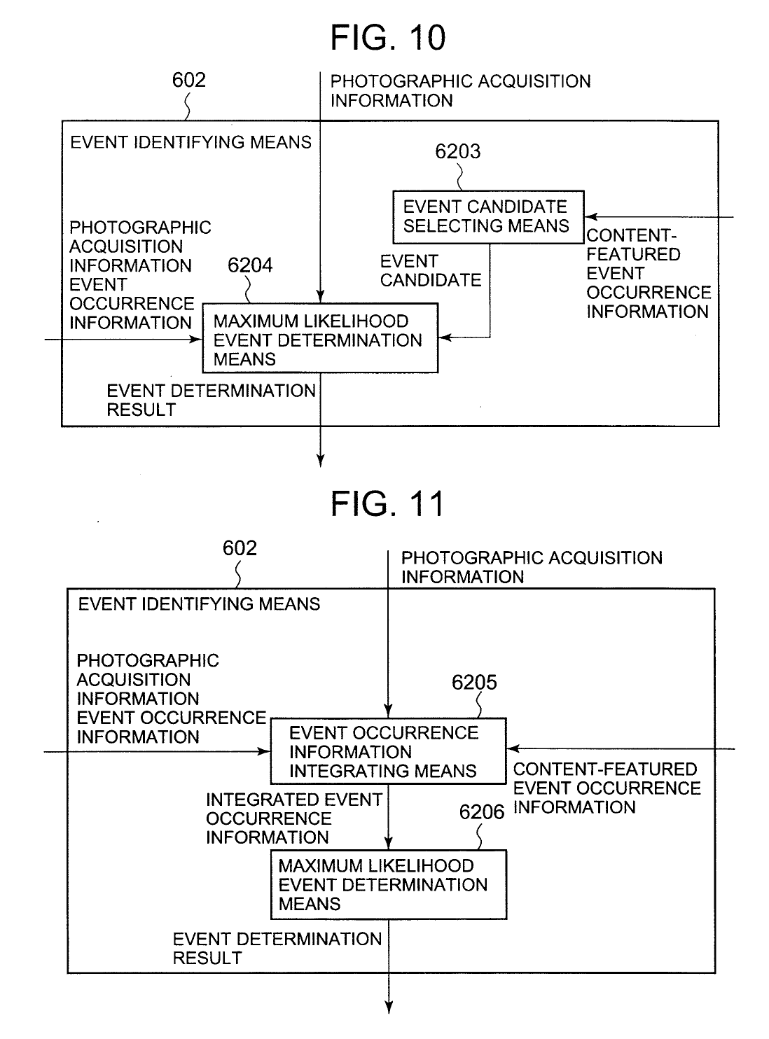

FIG. 10 is a block diagram showing an example of the event identifying means 602. The event identifying means 602 shown in FIG. 10 includes the event candidate selecting means 6203 and the maximum likelihood event determination means 6204.

The event identifying means 602 illustrated in FIG. 10 is similar in configuration to the event identifying means 602 illustrated in FIG. 8, but different in the following points: In the second exemplary embodiment, the event candidate selecting means 6201 illustrated in FIG. 8 first selects event candidates based on the photographic acquisition information received. After that, the maximum likelihood event determination means 6202 further selects an event candidate based on the content-featured event occurrence information. On the other hand, in the first alternative embodiment, the event candidate selecting means 6203 illustrated in FIG. 10 first selects events using the content-featured event occurrence information. After that, the maximum likelihood event determination means 6204 further selects an event candidate based on the photographic acquisition information received.

Specifically, the event candidate selecting means 6203 receives the content-featured event occurrence information from the content-featured event occurrence information calculating means 603, and outputs candidates for an event to which the contents input into the content input means 14 belong. The event candidate selecting means 6203 is similar to the maximum likelihood event determination means 6202 in the second exemplary embodiment, but different from the second exemplary embodiment in that it does not preselect event candidates using the photographic acquisition information.

Further, the maximum likelihood event determination means 6204 receives the event candidates from the event candidate selecting means 6203, the photographic acquisition information from the photographic acquisition information input means 11, and the event occurrence information on photographic acquisition information from the event occurrence information on photographic acquisition information correcting means 606, respectively. Then, among the event candidates, the maximum likelihood event determination means 6204 determines, as the event determination result, an event determined to be likely among the events whose photographic acquisition information corresponds to the photographic acquisition information in the event occurrence information on photographic acquisition information. The maximum likelihood event determination means 6204 is similar to the event candidate selecting means 6201 in the second exemplary embodiment, but different from the second exemplary embodiment in that the selection of event candidates using the content feature has been already made. The rest is the same as that in the second exemplary embodiment.

Next, the operation will be described. An example of processing performed by the content classification apparatus in the alternative embodiment is the same as the processing illustrated in the flowchart of FIG. 9, except that processing step S66 is different from the second exemplary embodiment. The following will describe such an operation that the event identifying means 602 determines in step S66 candidates for an event to which the contents belong.

First, the event candidate selecting means 6203 receives the content-featured event occurrence information from the content-featured event occurrence information calculating means 603, and selects candidates for the event to which the contents belong. Next, the maximum likelihood event determination means 6204 determines the event based on the event candidates selected by the event candidate selecting means 6203, the event occurrence information on photographic acquisition information received from the event occurrence information on photographic acquisition information correcting means 606, and the photographic acquisition information received from the photographic acquisition information input means 11.

Thus, according to the alternative embodiment, the event candidate selecting means 6203 selects the candidates for the classification destination event of the contents to be classified based on the degree indicated by the content-featured event occurrence information. Then, the maximum likelihood event determination means 6204 determines, as the classification destination event of the contents, an event determined to be likely among the events corresponding to the photographic acquisition information in the event occurrence information on photographic acquisition information from among the selected event candidates. Thus, since the event is determined based on the content feature amount as well as the photographic acquisition information, classification accuracy is further improved in addition to the effects of the first exemplary embodiment.

In other words, in the second exemplary embodiment, an event is determined based on the content feature amount after contents are narrowed down based on the photographic acquisition information. However, in the case of contents characterized by the content feature amount, it is better to narrow down events, based on the content feature amount in order to reduce the probability of being excluded from the event candidates at the first narrowing down stage. In such a case, as shown in the alternative embodiment, the event can be determined based on the photographic acquisition information after events are narrowed down based on the content feature amount, and this can further increase the accuracy of the event determination result. Especially, if the event candidate selecting means 6201 in the second exemplary embodiment and the event candidate selecting means 6203 in the alternative embodiment perform sufficient narrowing down processing, the effect will be pronounced.

Next, a second alternative embodiment of the second exemplary embodiment will be described. The second alternative embodiment differs from the second exemplary embodiment in that the event identifying means 602 includes event occurrence information integrating means 6205 and maximum likelihood event determination means 6206. The other elements are the same as those shown in FIG. 6 and FIG. 7. The description of the same configuration as that in the second exemplary embodiment will be omitted.

FIG. 11 is a block diagram showing an example of the event identifying means 602. The event identifying means 602 illustrated in FIG. 11 includes the event occurrence information integrating means 6205 and the maximum likelihood event determination means 6206.

The event identifying means 602 illustrated in FIG. 11 is similar in configuration to the event identifying means 602 illustrated in FIG. 8 and the event identifying means 602 illustrated in FIG. 10, but different in the following points: In the second exemplary embodiment, the event candidate selecting means 6201 illustrated in FIG. 8 first selects event candidates based on the photographic acquisition information received. After that, the maximum likelihood event determination means 6202 further selects an event candidate based on the content-featured event occurrence information. Further, in the first alternative embodiment, the event candidate selecting means 6203 illustrated in FIG. 10 selects events using the content-featured event occurrence information. After that, the maximum likelihood event determination means 6204 further selects an event candidate based on the photographic acquisition information received. On the other hand, the second alternative embodiment differs from the second exemplary embodiment and the first alternative embodiment in that the event occurrence information integrating means 6205 illustrated in FIG. 11 performs processing for selecting event candidates based on the received photographic acquisition information and processing for selecting an event candidate based on the content-featured event occurrence information at the same time.

The event occurrence information integrating means 6205 receives the event occurrence information on photographic acquisition information from the event occurrence information on photographic acquisition information correcting means 606, the photographic acquisition information from the photographic acquisition information input means 11, and the content-featured event occurrence information from the content-featured event occurrence information calculating means 603, respectively, and outputs event occurrence information in which the event occurrence information on photographic acquisition information and the content-featured event occurrence information are integrated (hereinafter referred to as integrated event occurrence information).

For example, suppose that the event occurrence information on photographic acquisition information is information representing how much each event occurs on a shooting date or location basis (i.e., event occurrence frequency information) or information obtained by performing density estimation and normalization processing on the event occurrence frequency information and expressing it as a probability (i.e., event occurrence probability information). Suppose also that information input as the content-featured event occurrence information is a score value indicative of the likelihood of each event. In this case, the event occurrence information integrating means 6205 may calculate a value by multiplying a value of event occurrence frequency information calculated for each event based on the photographic acquisition information or a value of event occurrence probability information by the score value calculated by using each content feature (hereinafter referred to as an event adjusted score value), and output the calculated event adjusted score value as the integrated event occurrence information.

The maximum likelihood event determination means 6206 receives the integrated event occurrence information from the event occurrence information integrating means 6205 and outputs an event determination result. For example, when the event occurrence information integrating means 6205 outputs the event adjusted score value as the integrated event occurrence information, the maximum likelihood event determination means 6206 may output an event with the top event adjusted score value or a few top events as the event determination result(s).

Next, the operation will be described. An example of processing performed by the content classification apparatus in the alternative embodiment is the same as the processing illustrated in the flowchart of FIG. 9, except that processing step S66 is different from the second exemplary embodiment. The following will describe such an operation that the event identifying means 602 determines in step S66 candidates for an event to which the contents belong.

First, the event occurrence information integrating means 6205 generates integrated event occurrence information based on the photographic acquisition information received from the event occurrence information on photographic acquisition information correcting means 606, the photographic acquisition information received from the photographic acquisition information input means 11, and the content-featured event occurrence information received from the content-featured event occurrence information calculating means 603. Then, the maximum likelihood event determination means 6206 determines an event based on the integrated event occurrence information received from the event occurrence information integrating means 6205.

Thus, according to the alternative embodiment, the event occurrence information integrating means 6205 outputs integrated event occurrence information based on the event occurrence information on photographic acquisition information, the photographic acquisition information on the contents to be classified, and the degree indicated by the content-featured event occurrence information. Then, the maximum likelihood event determination means 6206 determines, as the classification destination event of the contents, an event determined to be likely among the event occurrence information. Thus, since an event is determined based on the content feature amount as well as the photographic acquisition information, classification accuracy is further improved in addition to the effects of the first exemplary embodiment.

In other words, according to the alternative embodiment, since the photographic acquisition information and the content feature amount are used at the same time to determine a likely event from these two points of view, the accuracy of the event determination result can further be improved.

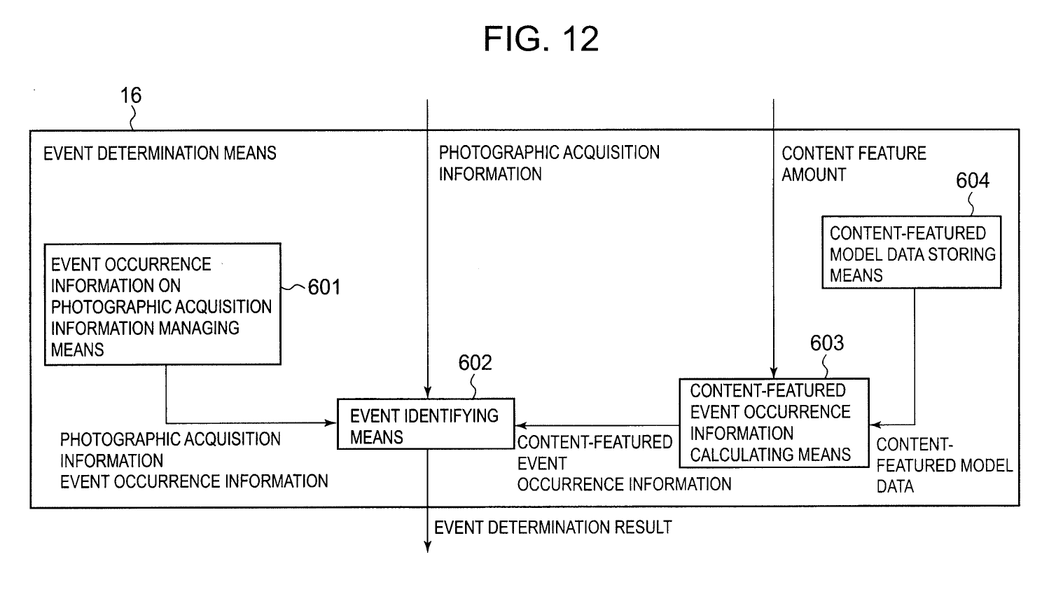

Next, a third alternative embodiment of the second exemplary embodiment will be described. FIG. 12 is a block diagram showing an example of the event determination means 16 in the third alternative embodiment. The third alternative embodiment differs from the second exemplary embodiment in that the event determination means 16 includes event occurrence information on photographic acquisition information managing means 601, event identifying means 602, content-featured event occurrence information calculating means 603, and content-featured model data storing means 604. The other elements are the same as those shown in FIG. 6. The same elements as those in the second exemplary embodiment are given the same reference numerals as in FIG. 6 and FIG. 7 to omit redundant description. Since the event identifying means 602, the content-featured event occurrence information calculating means 603, and the content-featured model data storing means 604 are the same as those in FIG. 7, the detailed description thereof will be omitted.

In comparison with the event occurrence information managing means 203 in the first exemplary embodiment, the event occurrence information on photographic acquisition information managing means 601 is different in that no base year information is output. In other words, the event occurrence information on photographic acquisition information managing means 601 outputs event occurrence information based on photographic acquisition information and a correct event stored in photographic acquisition information storing means (not shown). Note that the method of outputting the event occurrence information based on the photographic acquisition information and the correct event is the same as a method under which event occurrence information estimating means 2102 to be described later estimates and outputs event occurrence information.

Thus, an event can be determined based on the event occurrence information generated from the photographic acquisition information and the correct event, the photographic acquisition information, and the content feature amount. Note that, in the second exemplary embodiment, the event occurrence information on photographic acquisition information correcting means 606 corrects the event occurrence information. Therefore, even if the date when an event takes place is different year by year, it is more preferable because the contents representing the event can be classified properly and this can further improve classification accuracy.

### Exemplary Embodiment 3

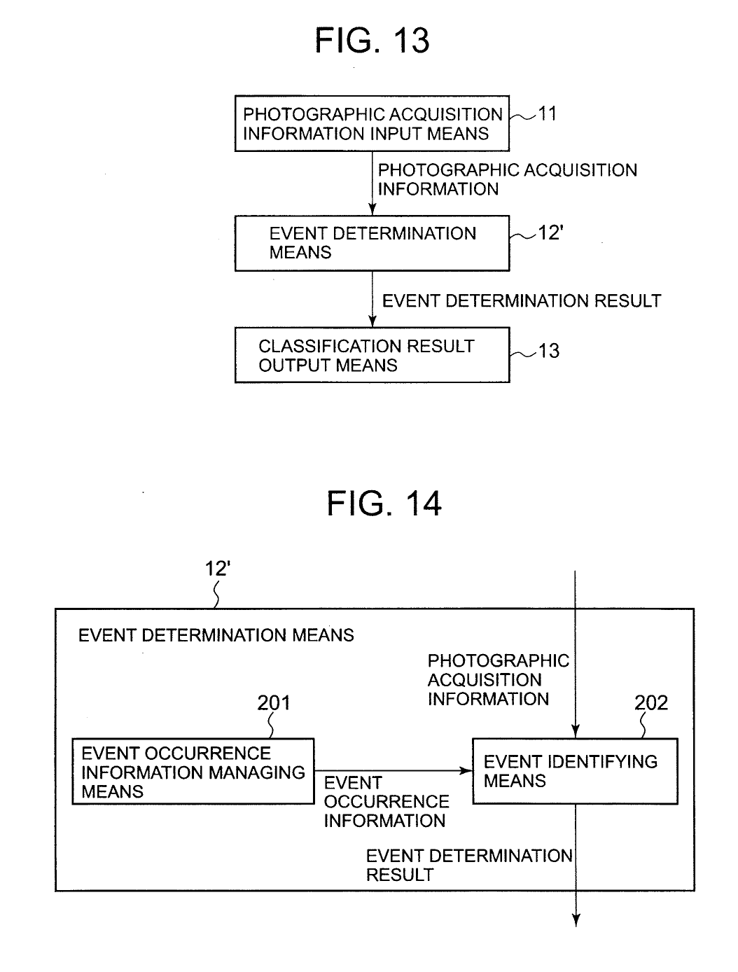

FIG. 13 is a block diagram showing an example of a content classification apparatus according to a third exemplary embodiment of the present invention. The content classification apparatus in the exemplary embodiment includes photographic acquisition information input means 11, event determination means 12′, and classification result output means 13.

Based on the photographic acquisition information received from the photographic acquisition information input means 11, the event determination means 12′ determines to which event input contents belong from among preset candidates for the classification destination event. Then, the event determination means 12′ notifies the classification result output means 13 of the determination result. Since the operation of the photographic acquisition information input means 11 and the classification result output means 13 is the same as that in the first exemplary embodiment, redundant description will be omitted.

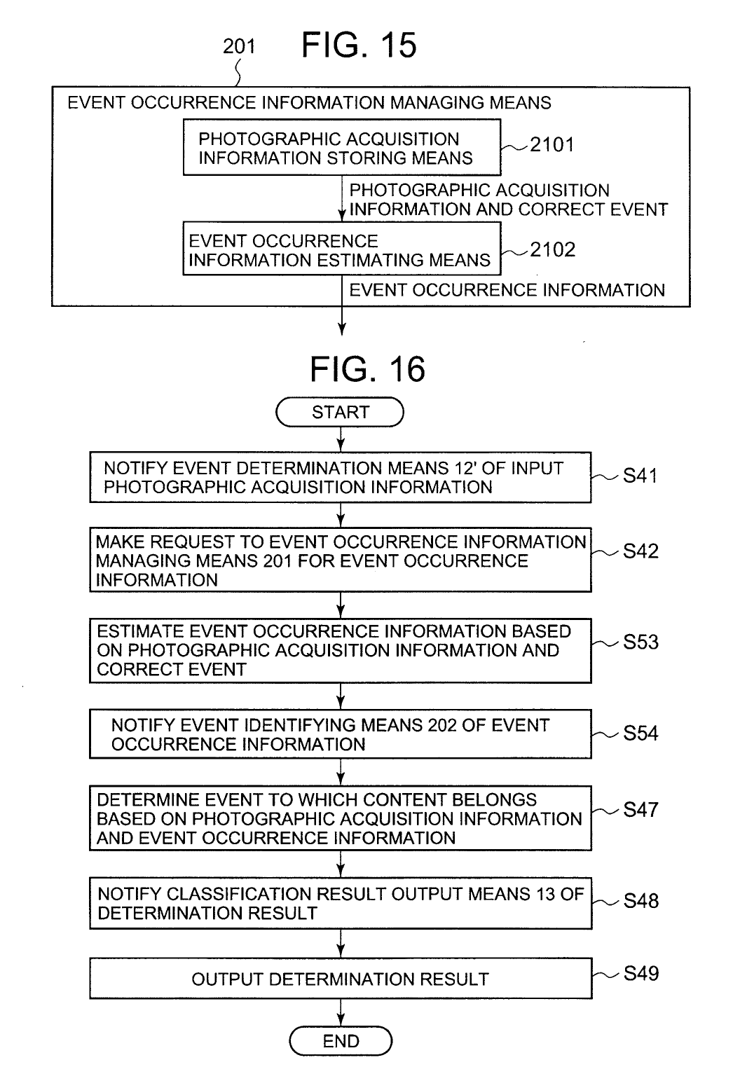

FIG. 14 is a block diagram showing an example of the event determination means 12′. The event determination means 12′ includes event occurrence information managing means 201 and event identifying means 202. FIG. 15 is a block diagram showing an example of the event occurrence information managing means 201. The event occurrence information managing means 201 includes photographic acquisition information storing means 2101 and event occurrence information estimating means 2102.

Like the photographic acquisition information storing means 2101 in the first exemplary embodiment, the photographic acquisition information storing means 2101 is implemented by a magnetic disk drive or the like included in the content classification apparatus to store various kinds of photographic acquisition information in association with classification destination events.

The event occurrence information estimating means 2102 reads photographic acquisition information and information on a correct event corresponding to the photographic acquisition information from the photographic acquisition information storing means 2101, and outputs event occurrence information estimated from these pieces of information. Then, the output event occurrence information is notified to the event identifying means 202.

The event occurrence information estimating means 2102 may output, as the event occurrence information, information read from the photographic acquisition information storing means 2101. For example, when the photographic acquisition information storing means 2101 stores shooting date information and classification destination event in association with each other, the event occurrence information estimating means 2102 may output event occurrence information in a format in which the date and the event are associated. Further, for example, when the photographic acquisition information storing means 2101 stores each event in association with a specific date (also referred to as “specified date”) from the beginning, the event occurrence information estimating means 2102 may output event occurrence information in a format in which the specified date is associated with a classification destination event.

The photographic acquisition information in the event occurrence information may be not only photographic acquisition information extracted from the contents, but also date information or the like specified by the user, for example. In this case, the event occurrence information estimating means 2102 may output event occurrence information in a format in which the classification destination event of contents is simply associated with the date information specified by the user. For example, the event occurrence information estimating means 2102 may output event occurrence information in which a classification destination event called the “Doll Festival” is associated with a date of “March 3,” event occurrence information in which an event called the “Star Festival” is associated with a date of July 7, and event occurrence information in which an event called “Halloween” is associated with a date of October 31, respectively. Note that information associated with the classification destination event as the event occurrence information may be not only a specified date but also information including extra days during which the event could occur, such as one week before and after the specified date.

Further, for example, when the photographic acquisition information storing means 2101 associates a certain period of dates with an event, the event occurrence information estimating means 2102 may output event occurrence information in a format in which the certain period of dates is associated with the event.

Further, for example, when the photographic acquisition information storing means 2101 stores shooting location information as the photographic acquisition information, the event occurrence information estimating means 2102 may output event occurrence information in a format in which a shooting location is associated with an event. Further, for example, when the photographic acquisition information storing means 2101 stores information in which multiple pieces of information are combined such as shooting location information and shooting date information in association with each event, the event occurrence information estimating means 2102 may output event occurrence information in a format in which the information with the shooting location information and the shooting date information combined is associated with the event.

Further, when the photographic acquisition information storing means 2101 stores occurrence frequency information and occurrence probability information on each event, the event occurrence information estimating means 2102 may output these pieces of occurrence frequency information and occurrence probability information as the event occurrence information. The event occurrence information estimating means 2102 may also calculate the occurrence frequency information and the occurrence probability information based on the information stored in the photographic acquisition information storing means 2101 to set these pieces of information as the event occurrence information.

Further, the event occurrence information estimating means 2102 may model the occurrence frequency information and the occurrence probability information using a function of normal distribution or the like to set information on the function and a model parameter exhibiting the fittest case as the event occurrence information.

As mentioned above, the event occurrence information managing means 201 (more specifically, the photographic acquisition information storing means 2101 and the event occurrence information estimating means 2102) outputs event occurrence information as a whole. In other words, since the event occurrence information managing means 201 outputs event occurrence information in various formats, it can be said that the event occurrence information managing means 201 has the function of performing statistical processing using multiple pieces of photographic acquisition information to output the processing result.

Based on the photographic acquisition information input into the photographic acquisition information input means 11 and the event occurrence information requested to the event occurrence information managing means 201, the event identifying means 202 determines to which event contents indicated by the photographic acquisition information belong, and outputs the determination result. Since the method under which the event identifying means 202 determines an event is the same as the method described in the first exemplary embodiment, redundant description will be omitted.

The photographic acquisition information input means 11, the event determination means 12′ (more specifically, the event occurrence information estimating means 2102 and the event identifying means 202), and the classification result output means 13 are implemented by a CPU of a computer operating according to a program (content classification program). For example, the program may be stored in a storage unit (not shown) of the content classification apparatus so that the CPU will read the program and operate according to the program as the photographic acquisition information input means 11, the event determination means 12′ (more specifically, the event occurrence information estimating means 2102 and the event identifying means 202), and the classification result output means 13. Alternatively, the photographic acquisition information input means 11, the event determination means 12′ (more specifically, the event occurrence information estimating means 2102 and the event identifying means 202), and the classification result output means 13 may be implemented through dedicated hardware, respectively.

Next, the operation will be described. FIG. 16 is a flowchart showing an example of processing performed by the content classification apparatus according to the exemplary embodiment. Note that the processing from when photographic acquisition information is input into the content classification apparatus until the event occurrence information managing means 201 is requested for event occurrence information is the same as the processing steps S41 and S42 in FIG. 5. When the event occurrence information managing means 201 receives a request, the event occurrence information estimating means 2102 reads the photographic acquisition information and the correct event from the photographic acquisition information storing means 2101, and estimates event occurrence information based thereon (step S53). Then, the event occurrence information estimating means 2102 notifies the event identifying means 202 of the event occurrence information estimated (step S54).

The processing from when the event identifying means 202 determines to which event contents indicated by the photographic acquisition information belong until the classification result output means 13 outputs the determination result is the same as the processing steps S47 to S49 in FIG. 5.

As mentioned above, according to the exemplary embodiment, on condition that the photographic acquisition information input into the photographic acquisition information input means 11 corresponds to photographic acquisition information in the event occurrence information output from the event occurrence information estimating means 2102, the event identifying means 202 determines an event determined to be likely among the events corresponding to the photographic acquisition information in the event occurrence information to be the classification destination event of the contents. Therefore, even if images of contents representing different events are similar to each other, these contents can be classified properly.

Further, in the exemplary embodiment, even if it is difficult to classify events based on image differences, an event can be identified using a difference between photographic acquisition information, thereby improving classification accuracy. In the first exemplary embodiment, however, in addition to the exemplary embodiment, the event occurrence information correcting means 204 corrects the event occurrence information based on the shooting date information, the event occurrence information, and the base year information. Therefore, the first exemplary embodiment is more preferable because the load of setting information for classifying events can be reduced in addition to the effects of the exemplary embodiment.

### Exemplary Embodiment 4

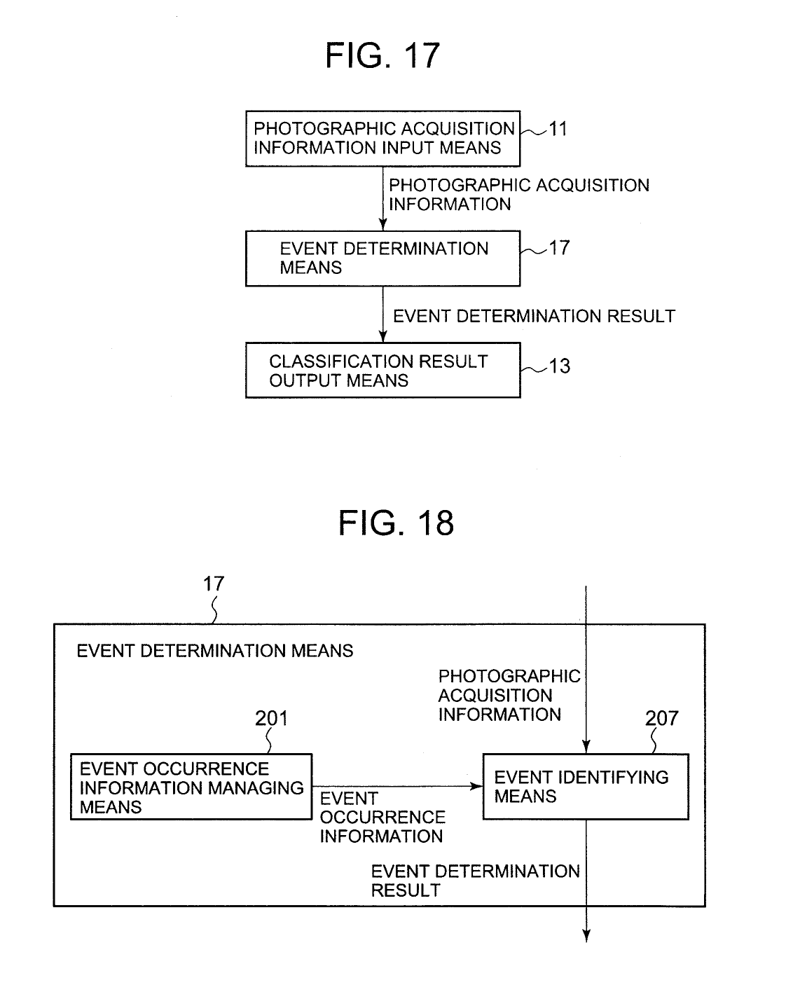

FIG. 17 is a block diagram showing an example of a content classification apparatus according to a fourth exemplary embodiment of the present invention. The content classification apparatus in the exemplary embodiment includes photographic acquisition information input means 11, event determination means 17, and classification result output means 13.

Based on photographic acquisition information received from the photographic acquisition information input means 11, the event determination means 17 determines to which event input contents belong from among preset candidates for the classification destination event. Then, the event determination means 17 notifies the classification result output means 13 of the determination result. Since the operation of the photographic acquisition information input means 11 and the classification result output means 13 is the same as that in the first exemplary embodiment, redundant description will be omitted.

FIG. 18 is a block diagram showing an example of the event determination means 17. The event determination means 17 includes event occurrence information managing means 201 and event identifying means 207. The event occurrence information managing means 201 includes photographic acquisition information storing means 2101 and event occurrence information estimating means 2102.

Like the photographic acquisition information storing means 2101 in the first exemplary embodiment, the photographic acquisition information storing means 2101 is implemented by a magnetic disk drive or the like included in the content classification apparatus to store various kinds of photographic acquisition information in association with classification destination events. In the exemplary embodiment, it is assumed that the photographic acquisition information storing means 2101 stores at least one pieces of information described in the first exemplary embodiment, namely the occurrence frequency information, the occurrence probability information, or the model parameter.

The event occurrence information estimating means 2102 reads, as a correct event corresponding to the photographic acquisition information and the photographic acquisition information, at least one piece of information, namely the occurrence frequency information, the occurrence probability information, or the model parameter, from the photographic acquisition information storing means 2101, and outputs event occurrence information estimated based thereon. Since all the occurrence frequency information, the occurrence probability information, and the model parameter are information usable for estimating an event, it can be said that these pieces of information are also event occurrence information. Therefore, the event occurrence information estimating means 2102 may output the occurrence frequency information, the occurrence probability information, or the model parameter stored in the photographic acquisition information storing means 2101 as the event occurrence information without any change. Then, the event occurrence information estimating means 2102 notifies the event identifying means 207 of the output event occurrence information. Since the other contents are the same as those of the event occurrence information estimating means 2102 in the third exemplary embodiment, the detailed description thereof will be omitted.

Based on the photographic acquisition information input into the photographic acquisition information input means 11 and the event occurrence information requested to the event occurrence information managing means 201, the event identifying means 207 determines to which event contents indicated by the photographic acquisition information belong, and outputs the determination result. At this time, the event identifying means 207 determines, to be likely, such an event that the occurrence frequency indicated by the occurrence frequency information or the probability of occurrence indicated by the occurrence probability information is higher. Then, as a result of the determination, the event identifying means 207 notifies the classification result output means 13 of the name of the event to which the contents are determined to belong, a number corresponding to each event, and the like. The number of event candidates notified from the event identifying means 207 may be one or more.

For example, the event identifying means 207 extracts an occurrence frequency corresponding to the photographic acquisition information input into the photographic acquisition information input means 11 from the occurrence frequency information received from the event occurrence information managing means 201. In other words, using the shooting date information in the photographic acquisition information input into the photographic acquisition information input means 11, the event identifying means 207 extracts the occurrence frequency of each event under this condition (i.e., the input shooting date information) from the occurrence frequency information received from the event occurrence information managing means 201.

Then, the event identifying means 207 determines, to be likely, such an event that the occurrence frequency corresponding to the photographic acquisition information on the contents to be classified is higher. For example, the event identifying means 207 determines an event with a higher frequency of occurrence to be the likely event. The event identifying means 207 may also determine all events with the occurrence frequencies being a certain value or more (a threshold or more) to be likely events. For example, when the shooting date information in the photographic acquisition information input into the photographic acquisition information input means 11 is December 25, the event identifying means 207 extracts the frequency of occurrence of each event on December 25 from the occurrence frequency information. Then, the event identifying means 207 may determine an event with the greatest frequency of occurrence to be the classification destination event.

The occurrence frequency information can be calculated by simple counting on a per-date basis or periodically. Further, when the number of photos used for counting is increased sufficiently to calculate the occurrence frequency information, the accuracy of classifying each content into an event can be improved even if the date when the event takes place relatively varies. Thus, since the event identifying means 207 determines a classification destination event using the occurrence frequency information, not only can the load of setting up a rule for classification be reduced, but also the content classification accuracy can be improved.

The same holds true even when the information the event identifying means 207 receives from the event occurrence information managing means 201 is occurrence probability information. In other words, the event identifying means 207 extracts an occurrence probability corresponding to the photographic acquisition information input into the photographic acquisition information input means 11 from the occurrence probability information received from the event occurrence information managing means 201. Then, the event identifying means 207 determines an event with the highest probability of occurrence to be the classification destination event of the contents. Here, the event identifying means 207 may determine all events with occurrence frequencies being a certain value or more (a threshold or more) to be classification destination events.

As mentioned above, since occurrence probability information is calculated based on a group of photos used for learning (counting), not only can the occurrence probability information on the extracted shooting date be calculated, but also occurrence probability information on dates around the shooting date can be interpolated. Thus, since the event identifying means 207 determines a classification destination event using the occurrence probability information, the load of setting up a rule for classification can be reduced even if the date when the event takes place relatively varies. This can increase the content classification accuracy more than the case where only the occurrence frequency information is used.

Further, the event identifying means 207 may determine, to be likely, an event whose likelihood calculated using a function (i.e., an approximate function) expressed by the model parameter is higher. Specifically, the event identifying means 207 calculates the likelihood based on the function specified by the model parameter received from the event occurrence information managing means 201. Then, the event identifying means 207 may determine, to be likely, an event with a higher likelihood. Since the method of deciding on the approximate function is the same as the method described in the first exemplary embodiment (e.g., the method of modeling the occurrence frequency information or the occurrence probability information using a Gaussian function), redundant description will be omitted.

For example, the event identifying means 207 calculates a value (likelihood) of each event corresponding to the photographic acquisition information based on the approximate function. Then, the event identifying means 207 determines an event with the largest value to be the classification destination event. Here, the event identifying means 207 may determine all events with values equal to or more than a certain value (equal to or more than a threshold) to be classification destination events.

For example, when the shooting date information in the photographic acquisition information input into the photographic acquisition information input means 11 is December 25, the event identifying means 207 calculates a value of each event on December 25 using a modeled function (i.e., an approximate function). Then, it determines an event with the largest value to be the classification destination event. The event identifying means 207 may determine all events with values equal to or more than a certain value (equal to or more than a threshold) to be classification destination events.

When the event occurrence information can be represented by the model parameter, only the information on the function and the parameter value have to be stored in the photographic acquisition information storing means 2101. In other words, there is no need to store, in the photographic acquisition information storing means 2101, occurrence frequency or occurrence probability information on a day-to-day basis. Therefore, when the event identifying means 207 determines a classification destination event using the model parameter, the load of setting up a rule for classification can be reduced. Note that use of the occurrence frequency information or the occurrence probability information can more increase the content classification accuracy. However, once a function for classification is decided on, the classification destinations of events can be determined after that based on correspondences expressed by the function, and this can make the classification processing easier.

Thus, the event identifying means 207 can determine, to be likely, such an event that the occurrence frequency or the occurrence probability in the photographic acquisition information on each event is higher. In other words, since it can be said that the value indicates the degree of likelihood of each event identified by the photographic acquisition information, the value can be called likelihood. Further, since the model parameter represents a distribution of likelihood of each event, this model parameter is synonymous with the function expressing the distribution of likelihood of each event.

The photographic acquisition information input means 11, the event determination means 17 (more specifically, the event occurrence information estimating means 2102 and the event identifying means 207), and the classification result output means 13 are implemented by a CPU of a computer operating according to a program (content classification program). Alternatively, the photographic acquisition information input means 11, the event determination means 17 (more specifically, the event occurrence information estimating means 2102 and the event identifying means 207), and the classification result output means 13 may be implemented through dedicated hardware, respectively.

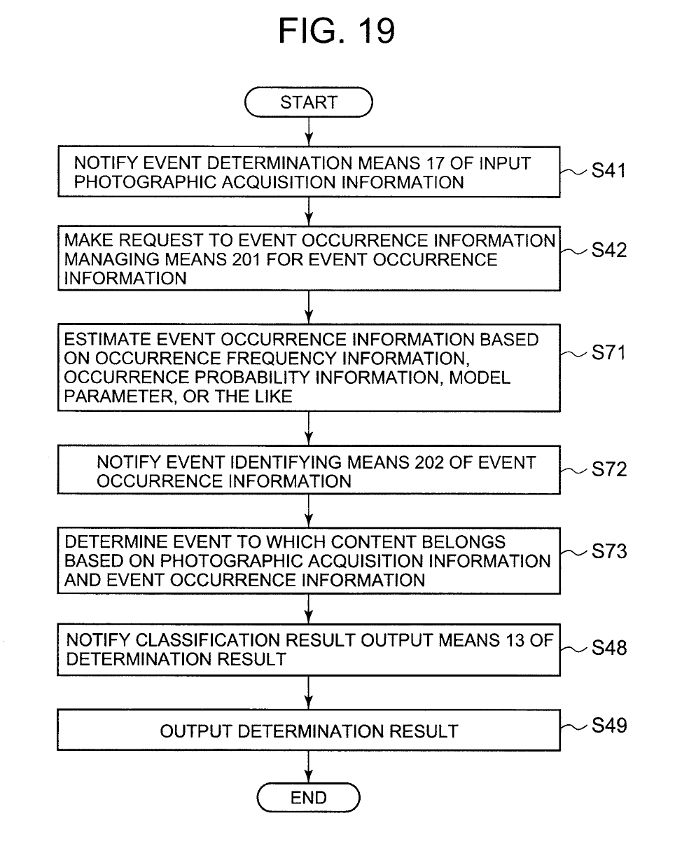

Next, the operation will be described. FIG. 19 is a flowchart showing an example of processing performed by the content classification apparatus according to the exemplary embodiment. The processing from when the photographic acquisition information is input into the content classification apparatus until the event occurrence information is stored in the event occurrence information managing means 201 is the same as the processing steps S41 and S42 in FIG. 16.

When the event occurrence information managing means 201 receives a request, the event occurrence information estimating means 2102 reads at least one piece of information among the occurrence frequency information, the occurrence probability information, and the model parameter from the photographic acquisition information storing means 2101, and estimates event occurrence information based thereon (step S71). Then, the event occurrence information estimating means 2102 notifies the event identifying means 207 of the estimated event occurrence information (step S72).

Based on the photographic acquisition information input into the photographic acquisition information input means 11 and the event occurrence information received, the event identifying means 207 determines to which event contents indicated by the photographic acquisition information belong. Specifically, the event identifying means 207 determines, to be likely, an event with a higher frequency of occurrence indicated by the occurrence frequency information or a higher probability of occurrence indicated by the occurrence probability information, or the event identifying means 207 determines, to be likely, an event with a larger value calculated based on the approximate function, to determine the event to be the classification destination event of the contents (step S73). After that, the processing from when the event identifying means 207 notifies the classification result output means 13 of the determination result until the processing until the classification result output means 13 outputs the determination result is the same as the processing steps S48 and S49 in FIG. 16.

As mentioned above, according to the exemplary embodiment, on condition that the event occurrence information estimated based on the occurrence frequency information, the occurrence probability information, the model parameter, or the like corresponds to the photographic acquisition information on the contents to be classified (e.g. they match in shooting date, or the photographic acquisition information is included within a certain period of shooting dates), the event identifying means 207 determines an event determined to be likely among the events in the event occurrence information corresponding to the photographic acquisition information to be the classification destination event of the contents. Specifically, based on the likelihood (e.g. the value calculated based on the occurrence frequency information, the occurrence probability information, or the approximate function), the event identifying means 207 determines, to be likely, an event with a higher likelihood corresponding to the photographic acquisition information on the contents to be classified. Therefore, even if images of contents representing different events are similar to each other, not only can these contents be classified properly, but also the load of setting information for classifying events can be reduced.

In other words, since the event identifying means 207 determines an event based on the photographic acquisition information, rather than the images themselves, these contents can be classified into appropriate events even if the content images are similar. Further, since the event identifying means 207 makes a determination based on the likelihood calculated based on the photographic acquisition information on the contents, the load of setting information for classifying events can be reduced. In addition, since the event identifying means 207 classifies contents using the occurrence frequency information, the occurrence probability information, the model parameter, or the like as the event occurrence information, accuracy for classification can be improved.

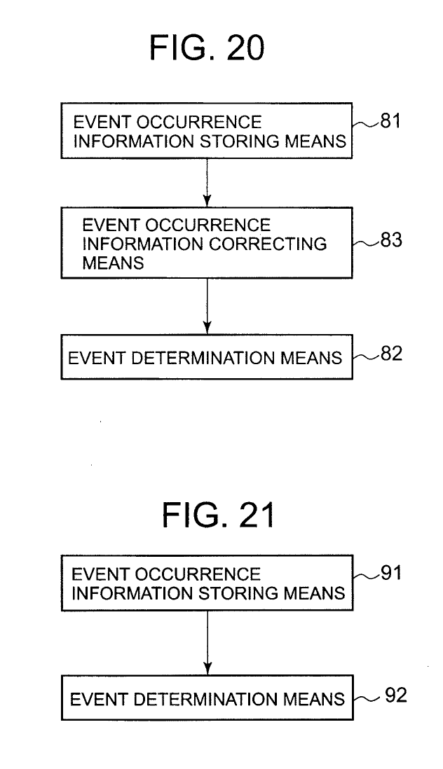

Next, a minimal configuration of the present invention will be described. FIG. 20 is a block diagram showing the minimal configuration of the present invention. The content classification apparatus according to the present invention includes: event occurrence information storing means 81 (e.g. the photographic acquisition information storing means 2101) for storing event occurrence information as information in which events (e.g. Christmas, Halloween, Doll Festival, entrance ceremony, sports day, etc.) into which contents (e.g. photos, videos (including short clips), sound, voice, etc.) are classified are associated with photographic acquisition information as content metadata (e.g. in addition to information representing the date, location, shooting environment, and the state of each photo or video taken with an imaging device, information representing the date, location and the like of sound or voice recorded with an imaging device, a recorder, or the like) including shooting date information indicative of the date when each content was shot; event determination means 82 (e.g. the event identifying means 202) for determining an event determined to be likely among events corresponding to photographic acquisition information in the event occurrence information to be an event into which the content should be classified on condition that the photographic acquisition information on the content to be classified corresponds to (e.g. matches with or matches within a predetermined range with) photographic acquisition information in the event occurrence information; and event occurrence information correcting means 83 (e.g. the event occurrence information correcting means 204) for correcting the event occurrence information based on shooting date information for multiple years and a base year (e.g. base year information) as a year used as a basis for comparing the shooting date information.

On condition that the shooting date information on the contents to be classified corresponds to the date of the event occurrence information corrected by the event occurrence information correcting means 83, the event determination means 82 determines an event determined to be likely among the events corresponding to the date of the event occurrence information to be the event into which the content should be classified.

According to such a configuration, even if images of contents representing different events are similar to each other, not only can these contents be classified into appropriate events, but also the load of setting information for classifying the events can be reduced.

Next, another minimal configuration of the present invention will be described. FIG. 21 is a block diagram showing the other minimal configuration of the present invention. The content classification apparatus according to the present invention includes: event occurrence information storing means 91 (e.g. the photographic acquisition information storing means 2101) for storing event occurrence information as information in which events (e.g. Christmas, Halloween, Doll Festival, entrance ceremony, sports day, etc.) into which contents (e.g. photos, videos (including short clips), sound, voice, etc.) are classified are associated with photographic acquisition information as metadata on the shot content (e.g. in addition to information representing the date, location, shooting environment, and the state of each photo or video taken with an imaging device, information representing the date, location and the like of sound or voice recorded with an imaging device, a recorder, or the like); and event determination means 92 (e.g. the event identifying means 207) for determining an event determined to be likely among events corresponding to photographic acquisition information in the event occurrence information to be an event into which the content should be classified on condition that the photographic acquisition information on each content to be classified corresponds to (e.g. matches with or matches within a predetermined range with) photographic acquisition information in the event occurrence information.

The event occurrence information storing means 91 stores a likelihood (e.g. occurrence frequency information or occurrence probability information) as a value calculated based on photographic acquisition information on multiple contents associated with each event to indicate the degree of likelihood of the event identified by the photographic acquisition information or a function (e.g. a model parameter) for calculating the likelihood, and the event determination means 92 determines, to be likely, an event higher in likelihood corresponding to the photographic acquisition information on the content to be classified.

According to such a configuration, even if images of contents representing different events are similar to each other, not only can these contents be classified into appropriate events, but also the load of setting information for classifying the events can be reduced.

Further, for example, the present invention can be applied to a cellular phone, a personal computer, and the like so that contents stored in these devices can be automatically classified into folders on a per-event basis.

It can be said that at least the following content classification apparatuses are described in any of the aforementioned exemplary embodiments:

(1) A content classification apparatus including: event occurrence information storing means (e.g. the photographic acquisition information storing means 2101) for storing event occurrence information as information in which each of events (e.g. Christmas, Halloween, Doll Festival, entrance ceremony, sports day, etc.) into which each of contents (e.g. photos, videos (including short clips), sound, voice, etc.) is classified is associated with photographic acquisition information as content metadata (e.g. in addition to information representing the date, location, shooting environment, and the state of each photo or video taken with an imaging device, information representing the date, location and the like of sound or voice recorded with an imaging device, a recorder, or the like) including shooting date information indicative of the date when each content was shot; event determination means (e.g. the event identifying means 202) for determining an event determined to be likely among events corresponding to photographic acquisition information in the event occurrence information to be an event into which the content should be classified on condition that the photographic acquisition information on the content to be classified corresponds to (e.g. matches with or matches within a predetermined range with) photographic acquisition information in the event occurrence information; and event occurrence information correcting means (e.g. the event occurrence information correcting means 204) for correcting the event occurrence information based on shooting date information for multiple years and a base year (e.g. base year information) as a year used as a basis for comparing the shooting date information, wherein on condition that the shooting date information on the content to be classified corresponds to the date of the event occurrence information corrected by the event occurrence information correcting means, the event determination means determines an event determined to be likely among the events corresponding to the date of the event occurrence information to be the event into which the content should be classified.

(2) The content classification apparatus further including content feature amount extracting means (e.g. the content feature extracting means 15) for extracting a content feature amount as information obtained by converting the feature of the content into a numeric value, wherein on condition that the photographic acquisition information on the content to be classified corresponds to photographic acquisition information in the event occurrence information, the event determination means determines, based on the content feature amount, an event determined to be likely among the events corresponding to the photographic acquisition information in the event occurrence information to be the event into which the content should be classified.

(3) The content classification apparatus further including content-featured event occurrence information calculating means (e.g. the content-featured event occurrence information calculating means 603) for calculating content-featured event occurrence information as information representing a degree, to which the content is classified into each event, based on content-featured model data (e.g., mean and variance in a feature space necessary to describe a Gaussian model) as information related to a model used to identify an event to which the content belongs and a content feature amount (e.g., color alignment in an image, color histogram, edge pattern histogram in each direction, visual feature amount in MPEG-7, or the like) as information obtained by converting the feature of the content into a numeric value, wherein on condition that the photographic acquisition information on the content to be classified corresponds to photographic acquisition information in the event occurrence information, the event determination means (e.g. the event identifying means 602) determines, based on the degree (e.g. score value) indicated by the content-featured event occurrence information, an event determined to be likely among the events corresponding to photographic acquisition information in the event occurrence information corrected by the event occurrence information correcting means (e.g. the event occurrence information on photographic acquisition information correcting means 606) to be the event into which the content should be classified.

(4) The content classification apparatus wherein when the photographic acquisition information on the content to be classified corresponds to the photographic acquisition information in the event occurrence information, the event determination means (e.g. the event candidate selecting means 6201 and the maximum likelihood event determination means 6202) extracts events, determined to be likely among the events corresponding to the photographic acquisition information in the event occurrence information, as candidates for the event into which the content should be classified, and among the extracted candidates, the event determination means determines the event into which the content should be classified based on the degree indicated by the content-featured event occurrence information.

(5) The content classification apparatus wherein the event determination means (e.g. the event candidate selecting means 6203 and the maximum likelihood event determination means 6204) extracts, based on the degree indicated by the content-featured event occurrence information, candidates for the event into which the content should be classified, and on condition that the photographic acquisition information on the content to be classified corresponds to the photographic acquisition information in the event occurrence information, the event determination means determines, from the event candidates, an event determined to be likely among the events corresponding to the photographic acquisition information in the event occurrence information to be the event into which the content should be classified.

(6) The content classification apparatus wherein the event determination means (e.g. the event occurrence information integrating means 6205 and the maximum likelihood event determination means 6206) generates event occurrence information (e.g. integrated event occurrence information) based on the event occurrence information (e.g. event occurrence information on photographic acquisition information), the photographic acquisition information on the content to be classified, and the degree indicated by the content-featured event occurrence information, and determines an event determined to be likely in the event occurrence information to be the event into which the content should be classified.

(7) The content classification apparatus wherein the event occurrence information storing means stores event occurrence information for multiple years, in which photographic acquisition information including shooting date information indicative of the date when the content was shot is associated with each event, the content classification apparatus further includes: event occurrence frequency information calculating means (e.g. the shooting year-based event occurrence frequency measuring means 23011) for calculating, based on the event occurrence information, event occurrence frequency information per shooting year as information obtained by counting up the number of contents corresponding to each event for each date identified by the shooting date information; day-of-the-week dependent element extracting means (e.g. the day-of-the-week dependent element separating means 23012) for extracting, from the event occurrence frequency information, a day-of-the-week dependent element indicative of the frequency of occurrence of each event dependent on the day of the week; and event occurrence information estimating means (e.g., day-of-the-week dependent element correcting means 23013) for estimating event occurrence information, (e.g. date-dependent element F1(d) and day-of-the-week dependent element F2(d)), in which an event is associated with the date when the event occurs, based on the day-of-the-week dependent element in each year consolidated according to a difference from a base year (e.g. base year information), and the event occurrence information correcting means corrects the event occurrence information estimated based on the base year and the shooting date information, and the event determination means (e.g. the event identifying means 202) determines an event determined to be likely among events corresponding to the date of the corrected event occurrence information to be the event into which the content should be classified.

(8) The content classification apparatus further including photographic acquisition information extracting means (not shown in Exemplary Embodiment 1) for storing photographic acquisition information extracted from content metadata in association with each event in the event occurrence information storing means.

(9) The content classification apparatus wherein the event occurrence information storing means stores event occurrence information in which photographic acquisition information including at least one piece of information among photographic acquisition information including shooting location information indicative of the location where the content was shot or the shooting date information is associated with each event, and on condition that the shooting date information or shooting location information on the content to be classified corresponds to photographic acquisition information in the event occurrence information, the event determination means determines an event determined to be likely among the events corresponding to the photographic acquisition information in the event occurrence information to be the event into which the content should be classified.

(10) A content classification apparatus including: event occurrence information storing means (e.g. the photographic acquisition information storing means 2101) for storing event occurrence information as information in which each of events (e.g. Christmas, Halloween, Doll Festival, entrance ceremony, sports day, etc.) into which each of contents (e.g. photos, videos (including short clips), sound, voice, etc.) is classified is associated with photographic acquisition information as metadata on the shot content (e.g. in addition to information representing the date, location, shooting environment, and the state of each photo or video taken with an imaging device, information representing the date, location and the like of sound or voice recorded with an imaging device, a recorder, or the like); and event determination means (e.g. the event identifying means 207) for determining an event determined to be likely among events corresponding to photographic acquisition information in the event occurrence information to be an event into which the content should be classified on condition that the photographic acquisition information on the content to be classified corresponds to (e.g. matches with or matches within a predetermined range with) the photographic acquisition information in the event occurrence information, wherein the event occurrence information storing means stores a likelihood (e.g. occurrence frequency information or occurrence probability information) as a value calculated based on photographic acquisition information on multiple contents associated with each event to indicate a degree of likelihood of the event identified by the photographic acquisition information or a function (e.g. a model parameter) for calculating the likelihood, and the event determination means determines, to be likely, an event higher in likelihood corresponding to the photographic acquisition information on the content to be classified.

(11) The content classification apparatus wherein the event occurrence information storing means stores, as the likelihood, an occurrence frequency (e.g. occurrence frequency information) as a value obtained by counting up, on per-event basis, photographic acquisition information on multiple contents associated with each event, and the event determination means determines, to be likely, an event higher in the occurrence frequency corresponding to the photographic acquisition information on the content to be classified.

(12) The content classification apparatus wherein the event occurrence information storing means counts up photographic acquisition information on multiple contents on a per-event basis (e.g. calculates occurrence frequency information), and stores, as the likelihood, an occurrence probability (e.g. occurrence probability information) of each event with respect to photographic acquisition information calculated based on the counted value, and the event determination means determines, to be likely, an event higher in the occurrence probability corresponding the photographic acquisition information on the content to be classified.

(13) The content classification apparatus wherein the event occurrence information storing means stores a function (e.g. an approximate function or a model parameter) with a minimal difference from a likelihood distribution for each event, and the event determination means determines, to be likely, an event higher in likelihood calculated by the function.

As described above, although the present invention is described with reference to the exemplary embodiments and examples, the present invention is not limited to the aforementioned exemplary embodiments and examples. Various changes that can be understood by those skilled in the art within the scope of the present invention can be made to the configurations and details of the present invention.

This application claims priority based on Japanese Patent Application No. 2009-156674, filed on Jul. 1, 2009, and Japanese Patent Application No. 2009-189459, filed on Aug. 18, 2009, the entire disclosures of which are incorporated herein by reference.

### INDUSTRIAL APPLICABILITY

The present invention can be suitably applied to a content classification apparatus for classifying contents by event.

### REFERENCE SIGNS LIST

11 Photographic Acquisition Information Input Means
12, 12′ Event Determination Means
13 Classification Result Output Means
14 Content Input Means
15 Content Feature Extracting Means
16, 17 Event Determination Means
201, 203 Event Occurrence Information Managing
Means
202, 207 Event Identifying Means
204 Event Occurrence Information Correcting Means
2101 Photographic Acquisition Information Storing Means
2102, 2301 Event Occurrence Information Estimating Means
23011 Shooting Year-Based Event Occurrence Frequency Measuring Means
23012 Day-of-the-Week Dependent Element Separating Means
23013 Day-of-the-Week Dependent Element Correcting Means
601 Event Occurrence Information on Photographic Acquisition Information Managing Means
602 Event Identifying Means
603 Content-Featured Event Occurrence Information Calculating Means
604 Content-Featured Model Data Storing Means
605 Event Occurrence Information on Photographic Acquisition Information Managing Means
606 Event Occurrence Information on Photographic Acquisition Information Correcting Means
6201, 6203 Event Candidate Selecting Means
6202, 6204, 6206 Maximum Likelihood Event Determination Means
6205 Event Occurrence Information Integrating Means

1. A content classification apparatus comprising:
an event occurrence information storing unit which stores event occurrence information as information in which an event into which a content is classified is associated with photographic acquisition information as content metadata including shooting date information indicative of a date when the content was shot;
an event determination unit which determines an event determined to be likely among events corresponding to photographic acquisition information in the event occurrence information to be an event into which the content should be classified on condition that the photographic acquisition information on the content to be classified corresponds to the photographic acquisition information in the event occurrence information; and
an event occurrence information correcting unit which corrects the event occurrence information based on shooting date information for multiple years and a base year as a year used as a basis for comparing the shooting date information,
wherein, on condition that the shooting date information on the content to be classified corresponds to a date of the event occurrence information corrected by the event occurrence information correcting unit, the event determination unit decides that an event determined to be likely among the events corresponding to the date of the event occurrence information is the event into which the content should be classified.

2. The content classification apparatus according to claim 1, further comprising
a content feature amount extracting unit which extracts a content feature amount as information obtained by converting a feature of the content into a numeric value,
wherein, on condition that the photographic acquisition information on the content to be classified corresponds to photographic acquisition information in the event occurrence information, the event determination unit decides, based on the content feature amount, that an event determined to be likely among the events corresponding to the photographic acquisition information in the event occurrence information is the event into which the content should be classified.

3. The content classification apparatus according to claim 1, further comprising
a content-featured event occurrence information calculating unit which calculates content-featured event occurrence information as information representing a degree, to which the content is classified into each event, based on content-featured model data as information related to a model used to identify an event to which the content belongs and a content feature amount as information obtained by converting a feature of the content into a numeric value,
wherein, on condition that the photographic acquisition information on the content to be classified corresponds to photographic acquisition information in the event occurrence information, the event determination unit decides, based on the degree indicated by the content-featured event occurrence information, that an event determined to be likely among the events corresponding to photographic acquisition information in the event occurrence information corrected by the event occurrence information correcting unit is the event into which the content should be classified.

4. The content classification apparatus according to claim 3, wherein when the photographic acquisition information on the content to be classified corresponds to the photographic acquisition information in the event occurrence information, the event determination unit extracts events determined to be likely among the events corresponding to the photographic acquisition information in the event occurrence information as candidates for the event into which the content should be classified, and among the extracted candidates, the event determination unit determines the event into which the content should be classified based on the degree indicated by the content-featured event occurrence information.

5. The content classification apparatus according to claim 3, wherein the event determination unit extracts, based on the degree indicated by the content-featured event occurrence information, candidates for the event into which the content should be classified, and on condition that the photographic acquisition information on the content to be classified corresponds to the photographic acquisition information in the event occurrence information, the event determination unit decides, from the event candidates, that an event determined to be likely among the events corresponding to the photographic acquisition information in the event occurrence information is the event into which the content should be classified.

6. The content classification apparatus according to claim 3, wherein the event determination unit generates event occurrence information based on the event occurrence information, the photographic acquisition information on the content to be classified, and the degree indicated by the content-featured event occurrence information, and decides that an event determined to be likely in the event occurrence information is the event into which the content should be classified.

7. The content classification apparatus according to claim 1, wherein
the event occurrence information storing unit stores event occurrence information for multiple years, in which the photographic acquisition information including the shooting date information is associated with each event,
the content classification apparatus further comprises:
an event occurrence frequency information calculating unit which calculates, based on the event occurrence information, event occurrence frequency information per shooting year as information obtained by counting up the number of contents corresponding to each event for each date identified by the shooting date information;
a day-of-the-week dependent element extracting unit which extracts, from the event occurrence frequency information, a day-of-the-week dependent element indicative of a frequency of occurrence of each event dependent on the day of the week; and
an event occurrence information estimating unit which estimates event occurrence information, in which an event is associated with a date when the event occurs, based on the day-of-the-week dependent element in each year consolidated according to a difference from a base year, and
the event occurrence information correcting unit corrects the event occurrence information estimated based on the base year and the shooting date information, and
the event determination unit decides that an event determined to be likely among events corresponding to a date of the corrected event occurrence information is the event into which the content should be classified.

8. The content classification apparatus according to claim 1, further comprising a photographic acquisition information extracting unit which stores photographic acquisition information extracted from content metadata in association with each event in the event occurrence information storing unit.

9. The content classification apparatus according to claim 1, wherein
the event occurrence information storing unit stores event occurrence information in which photographic acquisition information including at least one piece of information among photographic acquisition information including shooting location information indicative of a location where the content was shot or the shooting date information is associated with each event, and
on condition that the shooting date information or shooting location information on the content to be classified corresponds to photographic acquisition information in the event occurrence information, the event determination unit decides that an event determined to be likely among the events corresponding to the photographic acquisition information in the event occurrence information is the event into which the content should be classified.

10. A content classification apparatus comprising:
an event occurrence information storing unit which stores event occurrence information as information in which an event into which a content is classified is associated with photographic acquisition information as metadata on the shot content; and
an event determination unit which determines an event determined to be likely among events corresponding to photographic acquisition information in the event occurrence information to be an event into which the content should be classified on condition that the photographic acquisition information on the content to be classified corresponds to the photographic acquisition information in the event occurrence information,
wherein the event occurrence information storing unit stores a likelihood as a value calculated based on photographic acquisition information on multiple contents associated with each event to indicate a degree of likelihood of the event identified by the photographic acquisition information or a function for calculating the likelihood, and
the event determination unit determines, to be likely, an event higher in likelihood corresponding to the photographic acquisition information on the content to be classified.

11. The content classification apparatus according to claim 10, wherein
the event occurrence information storing unit stores, as the likelihood, occurrence frequency as a value obtained by counting up, on per-event basis, photographic acquisition information on multiple contents associated with each event, and
the event determination unit determines, to be likely, an event higher in the occurrence frequency corresponding to the photographic acquisition information on the content to be classified.

12. The content classification apparatus according to claim 10, wherein
the event occurrence information storing unit counts up photographic acquisition information on multiple contents on a per-event basis, and stores, as the likelihood, an occurrence probability of each event with respect to photographic acquisition information calculated based on the counted value, and
the event determination unit determines, to be likely, an event higher in the occurrence probability corresponding to the photographic acquisition information on the content to be classified.

13. The content classification apparatus according to claim 10, wherein
the event occurrence information storing unit stores a function with a minimal difference from a likelihood distribution for each event, and
the event determination unit determines, to be likely, an event higher in likelihood calculated by the function.

14. A content classification method comprising:
correcting event occurrence information as information, in which an event into which a content is classified is associated with photographic acquisition information including shooting date information as content metadata to indicate a date when the content was shot, based on the shooting date information for multiple years and a base year as a year used as a basis for comparing the shooting date information; and
deciding that an event determined to be likely among events corresponding to a date of the corrected event occurrence information is the event into which the content should be classified on condition that the shooting date information on the content to be classified corresponds to the date of the event occurrence information.

15. The content classification method according to claim 14, further comprising:
extracting a content feature amount as information obtained by converting a feature of the content into a numeric value, and
on condition that the photographic acquisition information on the content to be classified corresponds to photographic acquisition information in the event occurrence information, deciding, on the content feature amount, that an event determined to be likely among the events corresponding to photographic acquisition information in the event occurrence information is the event into which the content should be classified based.

16. The content classification method according to claim 14, further comprising:
calculating content-featured event occurrence information as information representing a degree, to which the content is classified into each event, based on content-featured model data as information related to a model used to identify an event to which the content belongs and a content feature amount as information obtained by converting a feature of the content into a numeric value,
on condition that the photographic acquisition information on the content to be classified corresponds to photographic acquisition information in the event occurrence information, deciding, based on the degree indicated by the content-featured event occurrence information, that an event determined to be likely among events corresponding to photographic acquisition information in the corrected event occurrence information is the event into which the content should be classified.

17. The content classification method according to claim 16, further comprising:
when the photographic acquisition information on the content to be classified corresponds to the photographic acquisition information in the event occurrence information, extracting events determined to be likely among the events corresponding to the photographic acquisition information in the event occurrence information are extracted as candidates for the event into which the content should be classified, and
determining the event into which the content should be classified among the extracted candidates, based on the degree indicated by the content-featured event occurrence information.

18. The content classification method according to claim 16, further comprising:
extracting candidates for the event into which the content should be classified, based on the degree indicated by the content-featured event occurrence information, and
on condition that the photographic acquisition information on the content to be classified corresponds to the photographic acquisition information in the event occurrence information, deciding, from the event candidates, that an event determined to be likely among the events corresponding to the photographic acquisition information in the event occurrence information is the event into which the content should be classified.

19. The content classification method according to claim 16, further comprising:
generating event occurrence information, based on the event occurrence information, the photographic acquisition information on the content to be classified, and the degree indicated by the content-featured event occurrence information, and
deciding that an event determined to be likely in the event occurrence information is the event into which the content should be classified.

20. The content classification method according to claim 14, further comprising:
calculating, per shooting year, event occurrence frequency information as information, obtained by counting up the number of contents corresponding to each event for each date identified by shooting date information, based on the event occurrence information in which photographic acquisition information including the shooting date information indicative of the date when the content was shot is associated with each event;
extracting, from the event occurrence frequency information, a day-of-the-week dependent element indicative of a frequency of occurrence of each event dependent on the day of the week;
estimating event occurrence information, in which an event is associated with a date when the event occurs, based on the day-of-the-week dependent element in each year consolidated according to a difference from a year as a basis for consolidating day-of-the-week dependent elements for multiple years;
correcting the event occurrence information based on the base year and the shooting date information; and
deciding that an event determined to be likely among events corresponding to a date of the corrected event occurrence information is the event into which the content should be classified.

21. The content classification method according to claim 14, further comprising:
on condition that shooting date information or shooting location information on the content to be classified corresponds to photographic acquisition information as photographic acquisition information in event occurrence information including at least one piece of information among photographic acquisition information including shooting location information indicative of a location where the content was shot or the shooting date information, deciding that an event determined to be likely among events corresponding to the photographic acquisition information in the event occurrence information is the event into which the content should be classified.

22. A content classification method comprising:
on condition that event occurrence information as information, in which an event into which a content is classified is associated with photographic acquisition information as metadata on the shot content, corresponds to photographic acquisition information on the content to be classified, deciding that an event determined to be likely among events in the event occurrence information corresponding to the photographic acquisition information is the event into which the content should be classified, and
when deciding the event into which the content should be classified, based on a likelihood as a value calculated based on photographic acquisition information on multiple contents associated with each event to indicate a degree of likelihood of the event identified by the photographic acquisition information, determining an event higher in likelihood corresponding to the photographic acquisition information on the content to be classified, to be likely.

23. The content classification method according to claim 22, further comprising:
when deciding the event into which the content should be classified, based on an occurrence frequency that is a value obtained by counting up, on a per-event basis, photographic acquisition information on multiple contents associated with each event, determining an event higher in occurrence frequency corresponding to the photographic acquisition information on the content to be classified, to be likely.

24. The content classification method according to claim 22, further comprising:
when deciding the event into which the content should be classified, counting up pieces of photographic acquisition information on multiple contents, on a per-event basis, and
determining an event higher in occurrence probability corresponding to the photographic acquisition information on the content to be classified, to be likely based on the occurrence probability of the event with respect to photographic acquisition information calculated based on the counted value.

25. The content classification method according to claim 22, further comprising:
when deciding the event into which the content should be classified, determining an event higher in likelihood corresponding to the photographic acquisition information on the content to be classified, to be likely, based on the likelihood calculated by a function with a minimal difference from a likelihood distribution for each event.

26. A computer readable information recording medium storing a program which, when executed by a processor, the processor having a storage storing event occurrence information as information in which an event into which a content is classified is associated with photographic acquisition information as content metadata including shooting date information indicative of a date when the content was shot, performs a method comprising:
deciding that an event determined to be likely among events corresponding to photographic acquisition information in the event occurrence information is the event into which the content should be classified on condition that the photographic acquisition information on the content to be classified corresponds to the photographic acquisition information in the event occurrence information; and
correcting the event occurrence information based on shooting date information for multiple years and a base year as a year used as a basis for comparing the shooting date information,
when deciding the event, on condition that the shooting date information on the content to be classified corresponds to the corrected date of the event occurrence information, deciding that an event determined to be likely among the events corresponding to the date of the event occurrence information is a classification destination event of the content.

27. The computer readable information recording medium according to claim 26, wherein the method further comprising:
extracting a content feature amount as information obtained by converting a feature of the content into a numeric value, and
on condition that the photographic acquisition information on the content to be classified corresponds to photographic acquisition information in the event occurrence information, deciding, on the content feature amount, that an event determined to be likely among the events corresponding to the photographic acquisition information in the event occurrence information is the event into which the content should be classified based.

28. A computer readable information recording medium storing a program which, when executed by a processor, the processor having a storage storing a likelihood as a value, calculated based on event occurrence information as information in which an event into which a content is classified is associated with photographic acquisition information as metadata on the shot content, and photographic acquisition information on multiple contents associated with each event, to indicate a degree of likelihood of the event identified by the photographic acquisition information, or a function for calculating the likelihood, performs a method comprising:
deciding that an event determined to be likely among events corresponding to photographic acquisition information in the event occurrence information is the event into which the content should be classified on condition that the photographic acquisition information on the content to be classified corresponds to the photographic acquisition information in the event occurrence information,
determining an event higher in likelihood corresponding to the photographic acquisition information on the content to be classified, to be likely.

29. The computer readable information recording medium according to claim 28, the computer including a storage storing, as a likelihood, an occurrence frequency obtained by counting up, on a per-event basis, photographic acquisition information on multiple contents associated with each event, wherein the method further comprising:
determining an event higher in occurrence frequency corresponding to the photographic acquisition information on the content to be classified, to be likely.

30. The computer readable information recording medium according to claim 28, the computer including a storage storing an occurrence probability of each event with respect to photographic acquisition information calculated based on the counted value as a likelihood, wherein the counted value is obtained by counting up photographic acquisition information on multiple contents on a per-event basis, wherein the method further comprising:
determining an event higher in occurrence probability corresponding to the photographic acquisition information on the content to be classified, to be likely.

31. The computer readable information recording medium according to claim 28, the computer including a storage storing a function with a minimal difference from a likelihood distribution for each event, wherein the method further comprising:
determining an event higher in likelihood calculated by the function, to be likely.
